(19) United States
(12) Patent Application Publication
(10) Pub. No.: US 2015/0170460 A1
(43) Pub. Date: Jun. 18, 2015

(54) Gaming Machine with Augmentable Multiplier Feature

(71) Applicant: Pridefield Limited, Douglas (IM)

(72) Inventor: Zania Marais, Durban (ZA)

(21) Appl. No.: 14/543,513

(22) Filed: Nov. 17, 2014

(30) Foreign Application Priority Data
Nov. 18, 2013 (GB) 1320353.4

(51) Int. Cl. G07F 17/32; G07F 17/34

(52) U.S. Cl. CPC G07F 17/3213; G07F 17/34

(57) ABSTRACT

A machine includes a display, a processor, and a non-transitory computer readable medium storing program instructions, that when executed by the processor, cause a set of functions to be performed that include making a first determination that a first trigger event occurred; responsive to the first determination, selecting a multiplier symbol set from a multiplier symbol group, and for a or each multiplier symbol of the selected multiplier symbol set, determining a respective corresponding arrangement position that indicates a significant figure of a bonus multiplier; making a second determination whether or not a second trigger event occurred; responsive to the second determination, when the second trigger event occurred: selecting a further multiplier symbol from the multiplier symbol group, augmenting a magnitude of the bonus multiplier based on the further multiplier symbol, and displaying the augmented bonus multiplier; and when the second trigger event did not occur: displaying the bonus multiplier.

### PRIORITY

This application claims priority under 35 U.S.C. §119 to United Kingdom Patent Application No. 1320353.4 filed Nov. 18, 2013, which is hereby incorporated by reference in its entirety.

### TECHNICAL FIELD

This disclosure relates to gaming machines for playing games such as wager games.

### BACKGROUND

Wager games come in a variety of forms, including for example a mechanical slot machine. A mechanical slot machine may include one or more reels, each of which includes multiple symbols distributed around the circumference of the reel. When a player places a wager (e.g., by placing a coin in the machine), the player is allowed to spin the reels. Each reel then comes to rest, typically with either one of the symbols, or a space in between symbols, in alignment with a pay line. A predetermined winning symbol or a predetermined combination of winning symbols that are aligned with the pay line may result in the player winning the game and receiving a payout. In one example, the machine may include three reels, and the pay line may be a horizontal line disposed across a center of each of the three reels.

In another example of a wager game, a mechanical slot machine may present symbols in a matrix arrangement, with each symbol changing during a spin of the game. For example, the machine may have five columns and three rows of symbols, for a total of fifteen symbols. Such machines often have multiple pay lines, each being defined by a collection of positions within the matrix. For example, the machine may have three pay lines, each corresponding to one row of the matrix.

While slot machines were traditionally mechanical, modern slot machines often take the form of a video gaming machine (e.g., a dedicated gaming machine located in a casino) that includes a graphical user interface (GUI), and that may emulate a mechanical slot machine. With a video gaming machine, the GUI may include a display that displays an image of one or more reels or a matrix as described above, together with animation effects to simulate a spin of the game. A computer software program, which may reside in the video gaming machine, may randomly select one or more symbols in response to a spin, and may display the result on the display.

Modern slot machines may include additional features beyond that of a traditional slot machine. Such features may include additional play modes. Such additional play modes may take the form of a bonus round that may increase the payout of the wager game under certain conditions.

A modern slot machine may also be played over a computer network, such as by a player using a client machine that is connected to a server machine over the computer network. In this instance, the server machine may perform the spins of the game and may send the resulting symbols to the client machine for display.

### SUMMARY

Viewed from one aspect, the disclosure describes a gaming machine for playing a game in which symbols are selected and/or displayed by the machine, the machine comprising means for selecting symbols and means for displaying symbols characterised in that the machine is configured to carry out the following functions: making a first determination that a first trigger event occurred; responsive to making the first determination, (i) selecting a multiplier symbol set from a multiplier symbol group, and (ii) for a or each multiplier symbol of the selected multiplier symbol set, determining a respective corresponding arrangement position, wherein the or each respective corresponding arrangement position indicates a significant figure of a bonus multiplier; making a second determination whether or not a second trigger event occurred; responsive to making the second determination, when the second trigger event occurred: (i) selecting a further multiplier symbol from the multiplier symbol group, (ii) augmenting a magnitude of the bonus multiplier based on the further multiplier symbol, and (iii) displaying on the display the augmented bonus multiplier by displaying the or each multiplier symbol in the selected multiplier symbol set in the corresponding arrangement position for the or each respective multiplier symbol in the selected multiplier symbol set and the further multiplier symbol; and when the second trigger event did not occur: displaying on the display the bonus multiplier by displaying the or each multiplier symbol in the selected multiplier symbol set in the corresponding arrangement position for the or each respective multiplier symbol in the selected multiplier symbol set.

The machine may further be configured for receiving a play request via a user interface. In this instance, the machine may make the determination in response to receiving the play request.

In some embodiments, the first trigger event comprises a randomly occurring event. For instance, the first trigger event may involve the machine selecting a particular trigger symbol, such as in connection with a previous play of the game.

In some embodiments, the second trigger event comprises a randomly occurring event. In some embodiments, the second trigger event comprises a selecting a particular trigger symbol from the multiplier symbol set and a particular corresponding arrangement position. The particular trigger symbol may indicate a zero.

The further multiplier symbol comprises one or more multiplier symbols from the multiplier symbol set.

In some embodiments, augmenting the magnitude of the bonus multiplier comprises using the further multiplier symbol as a most significant figure of the augmented bonus multiplier.

In some embodiments, the or each multiplier symbol in the multiplier symbol group corresponds to a respective number from a set of numbers. Selecting the multiplier symbol set from the multiplier symbol group may comprise using a random number generator to select numbers from the set of numbers to select multiplier symbols corresponding with the selected numbers. Likewise, selecting the further multiplier symbol from the multiplier symbol group may comprise using a random number generator to select at least one number from the set of numbers to select the further multiplier symbol corresponding with the at least one selected number.

In some embodiments, the multiplier symbol set comprises one or more instances of the or each multiplier symbol in the multiplier symbol group. Selecting the multiplier symbol set from the multiplier symbol group may comprise determining a quantity of multiplier symbols in the multiplier symbol set.

In some embodiments, the machine may be further configured to determine an arrangement from the or each respective corresponding arrangement position. The arrangement may be a linear arrangement. In some embodiments, the arrangement indicates a pay line.

The or each symbol in the multiplier symbol group may correspond with a respective displayable image, and the further multiplier symbol may correspond with a further displayable image.

In some embodiments, displaying on the display the augmented bonus multiplier comprises, for the or each multiplier symbol of the multiplier symbol set and the further multiplier symbol, displaying a corresponding displayable image.

In some embodiments, the machine may be further configured to display on the display one or more instances of the multiplier symbols from the multiplier symbol group on one or more reels, wherein the one or more reels comprise one or more symbol arrangement positions. The one or more reels may be arranged as one or more concentric reels (e.g., concentric rings), wherein the one or more symbol arrangement positions are distributed around the circumference of each of the one or more concentric rings. The machine displays the one or more instances of the multiplier symbol group in the one or more symbol arrangement positions. The machine may spin each of the concentric rings around a central axis and then stop each concentric ring so that each multiplier symbol in the multiplier symbol set forms an arrangement. The arrangement may be a linear arrangement, and may indicate a pay line.

The machine can be configured to display a set of reels that illustrate occurrence of the first trigger event. The display can illustrate movement of the set of reels that illustrate occurrence of the first trigger event linearly on the display. As an example, the linear movement of each reel can be in a direction from a top of the display towards a bottom of the display, in a direction from a bottom of the display towards the top of the display, in a direction from a right side of the display towards the left side of the display, or in a direction from the left side of the display toward the right side of the display. The machine can be configured to change from displaying the set of linearly moving reels to displaying the set of concentric reels.

In another embodiment, the machine can display symbols of the multiplier symbol group as a second set of linearly moving reels. The machine can be configured to change from displaying the set of linearly moving reels that illustrate occurrence of the first trigger event to displaying a second set of linearly moving reels that illustrate the symbols of the multiplier symbol group.

In some embodiments, the game may be a wager game. The display may be configured to display symbols in a wager game. The machine may be further configured to: receive a wager via a user interface; and determine a payout amount, wherein the payout amount is a function of at least the received wager. When the second trigger event did not occur, the determined payout amount may be a function of at least the received wager and the bonus multiplier. When the second trigger event occurred, the determined payout amount may be a function of at least the received wager and the augmented bonus multiplier. The determined payout amount may be displayed on the display.

The machine may be in the form of a stand-alone gaming machine which incorporates a data processing module and a display. Alternatively, the machine may comprise a server machine and a client machine which incorporates a data processing module and a display, the server machine and the client machine being remote from each other.

Viewed from a second aspect, the disclosure describes a method for playing a game in which symbols are selected and/or displayed, the method comprising: a machine making a first determination that a first trigger event occurred; responsive to making the first determination, the machine (i) selecting a multiplier symbol set from a multiplier symbol group, and (ii) for a or each multiplier symbol of the selected multiplier symbol set, determining a respective corresponding arrangement position, wherein the or each respective corresponding arrangement position indicates a significant figure of a bonus multiplier; the machine making a second determination whether or not a second trigger event occurred; responsive to making the second determination, the machine, when the second trigger event occurred: (i) selecting a further multiplier symbol from the multiplier symbol group, (ii) augmenting a magnitude of the bonus multiplier based on the further multiplier symbol, and (iii) displaying on a display the augmented bonus multiplier by displaying the or each multiplier symbol in the selected multiplier symbol set in the corresponding arrangement position for the or each respective multiplier symbol in the selected multiplier symbol set and the further multiplier symbol; and when the second trigger event did not occur: displaying on the display the bonus multiplier by displaying the or each multiplier symbol in the selected multiplier symbol set in the corresponding arrangement position for the or each respective multiplier symbol in the selected multiplier symbol set.

Viewed from a third aspect, the disclosure describes a server machine for use in playing a game in which symbols are selected and/or displayed, the server machine being configured to communicate with a client machine over a computer network, and the server machine comprising a processor and a computer-readable medium storing software instructions, that when executed by the processor, perform functions on the server machine comprising: making a first determination that a first trigger event occurred; responsive to making the first determination, (i) selecting a multiplier symbol set from a multiplier symbol group, and (ii) for a or each multiplier symbol of the selected multiplier symbol set, determining a respective corresponding arrangement position, wherein the or each respective corresponding arrangement position indicates a significant figure of a bonus multiplier; making a second determination whether or not a second trigger event occurred; responsive to making the second determination, when the second trigger event occurred: (i) selecting a further multiplier symbol from the multiplier symbol group, (ii) augmenting a magnitude of the bonus multiplier based on the further multiplier symbol, and (iii) sending to a client machine for display the augmented bonus multiplier by displaying the or each multiplier symbol in the selected multiplier symbol set in the corresponding arrangement position for the or each respective multiplier symbol in the selected multiplier symbol set and the further multiplier symbol; and when the second trigger event did not occur: sending to the client machine for display the bonus multiplier by displaying the or each multiplier symbol in the selected multiplier symbol set in the corresponding arrangement position for the or each respective multiplier symbol in the selected multiplier symbol set.

Viewed from a fourth aspect, the disclosure describes a client machine for playing a game in which symbols are selected and/or displayed, the client machine being in communication with a server machine and comprising: a display configured to display symbols; a processor; and a computer-readable medium storing software instructions, that when executed by the processor, perform functions on the client machine, the functions comprising: receiving from a server machine a first determination that a first trigger event occurred; responsive to receiving the first determination, (i) receiving from the server machine a multiplier symbol set from a multiplier symbol group, and (ii) for a or each multiplier symbol of the selected multiplier symbol set, displaying on the display the or each multiplier symbol in a respective corresponding arrangement position, wherein the or each respective corresponding arrangement position indicates a significant figure of a bonus multiplier; receiving from a server machine a second determination whether or not a second trigger event occurred; responsive to receiving the second determination, when the second trigger event occurred: (i) receiving from the server machine a further multiplier symbol from the multiplier symbol group, and (ii) displaying on the display an augmented bonus multiplier by displaying the or each multiplier symbol in the selected multiplier symbol set in the corresponding arrangement position for the or each respective multiplier symbol in the selected multiplier symbol set and the further multiplier symbol; and when the second trigger event did not occur: displaying on the display the bonus multiplier by displaying the or each multiplier symbol in the selected multiplier symbol set in the corresponding arrangement position for the or each respective multiplier symbol in the selected multiplier symbol set.

Viewed from a fifth aspect, the disclosure describes a computer software product for configuring a data processing system for playing a game in which symbols are selected and/or displayed, the software product comprising instructions, that when executed by a processor of the data processing system will cause the data processing system to carry out the following functions: making a first determination that a first trigger event occurred; responsive to making the first determination, (i) selecting a multiplier symbol set from a multiplier symbol group, and (ii) for a or each multiplier symbol of the selected multiplier symbol set, determining a respective corresponding arrangement position, wherein the or each respective corresponding arrangement position indicates a significant figure of a bonus multiplier; making a second determination whether or not a second trigger event occurred; responsive to making the second determination, when the second trigger event occurred: (i) selecting a further multiplier symbol from the multiplier symbol group, (ii) augmenting a magnitude of the bonus multiplier based on the further multiplier symbol, and (iii) displaying on the display the augmented bonus multiplier by displaying the or each multiplier symbol in the selected multiplier symbol set in the corresponding arrangement position for the or each respective multiplier symbol in the selected multiplier symbol set and the further multiplier symbol; and when the second trigger event did not occur: displaying on the display the bonus multiplier by displaying the or each multiplier symbol in the selected multiplier symbol set in the corresponding arrangement position for the or each respective multiplier symbol in the selected multiplier symbol set.

The features listed above as being features of embodiments of the first aspect of the disclosure, are equally applicable to embodiments of the second, third, fourth and fifth aspects of the disclosure.

In embodiments of the disclosure in which a computer software product is used, the product may be non-transitory and store instructions on physical media such as a DVD, or a solid state drive, or a hard drive. Or, the product may be an integrated circuit on a semiconductor chip, as a further example. Alternatively, the product may be transitory and in the form of instructions provided over a connection such as a network connection which is linked to a network such as the Internet.

Disclosed herein are machines and methods for playing games such as wager games. In one aspect, a machine is disclosed that includes a display configured to display symbols in a game, a processor, and a non-transitory computer-readable medium storing software program instructions, that when executed by the processor, cause a set of functions to be performed. The set of functions includes: making a first determination that a first trigger event occurred; responsive to making the first determination, (i) selecting a multiplier symbol set from a multiplier symbol group, and (ii) for a or each multiplier symbol of the selected multiplier symbol set, determining a respective corresponding arrangement position, wherein the or each respective corresponding arrangement position indicates a significant figure of a bonus multiplier; making a second determination whether or not a second trigger event occurred; responsive to making the second determination, when the second trigger event occurred: (i) selecting a further multiplier symbol from the multiplier symbol group, (ii) augmenting a magnitude of the bonus multiplier based on the further multiplier symbol, and (iii) displaying on the display the augmented bonus multiplier by displaying the or each multiplier symbol in the selected multiplier symbol set in the corresponding arrangement position for the or each respective multiplier symbol in the selected multiplier symbol set and the further multiplier symbol; and when the second trigger event did not occur: displaying on the display the bonus multiplier by displaying the or each multiplier symbol in the selected multiplier symbol set in the corresponding arrangement position for the or each respective multiplier symbol in the selected multiplier symbol set.

In another aspect, a method for use with a display configured to display symbols in a game is disclosed. The method involves: making, using a processor, a first determination that a first trigger event occurred; responsive to making the first determination, (i) selecting a multiplier symbol set from a multiplier symbol group, and (ii) for a or each multiplier symbol of the selected multiplier symbol set, determining a respective corresponding arrangement position, wherein the or each respective corresponding arrangement position indicates a significant figure of a bonus multiplier; making a second determination whether or not a second trigger event occurred; responsive to making the second determination, when the second trigger event occurred: (i) selecting a further multiplier symbol from the multiplier symbol group, (ii) augmenting a magnitude of the bonus multiplier based on the further multiplier symbol, and (iii) sending to a client machine for display the augmented bonus multiplier by displaying the or each multiplier symbol in the selected multiplier symbol set in the corresponding arrangement position for the or each respective multiplier symbol in the selected multiplier symbol set and the further multiplier symbol; and when the second trigger event did not occur: sending to the client machine for display the bonus multiplier by displaying the or each multiplier symbol in the selected multiplier symbol set in the corresponding arrangement position for the or each respective multiplier symbol in the selected multiplier symbol set.

In another aspect, a server machine is disclosed. The server machine is configured to communicate with a client machine over a computer-network, the client machine including a display configured to display symbols in a game. The server machine includes a processor and a non-transitory computer-readable medium storing software instructions, that when executed by the processor, perform a set of functions. The set of functions includes: making a first determination that a first trigger event occurred; responsive to making the first determination, (i) selecting a multiplier symbol set from a multiplier symbol group, and (ii) for a or each multiplier symbol of the selected multiplier symbol set, determining a respective corresponding arrangement position, wherein the or each respective corresponding arrangement position indicates a significant figure of a bonus multiplier; making a second determination whether or not a second trigger event occurred; responsive to making the second determination, when the second trigger event occurred: (i) selecting a further multiplier symbol from the multiplier symbol group, (ii) augmenting a magnitude of the bonus multiplier based on the further multiplier symbol, and (iii) sending to a client machine for display the augmented bonus multiplier by displaying the or each multiplier symbol in the selected multiplier symbol set in the corresponding arrangement position for the or each respective multiplier symbol in the selected multiplier symbol set and the further multiplier symbol; and when the second trigger event did not occur: sending to the client machine for display the bonus multiplier by displaying the or each multiplier symbol in the selected multiplier symbol set in the corresponding arrangement position for the or each respective multiplier symbol in the selected multiplier symbol set.

In another aspect, a client machine is disclosed. The client machine is configured to communicate with a server machine over a computer network. The client machine includes a display configured to display symbols of a game, a processor, and a non-transitory computer-readable medium storing software instructions, that when executed by the processor, perform a set of functions. The set of functions includes: receiving from a server machine a first determination that a first trigger event occurred; responsive to receiving the first determination, (i) receiving from the server machine a multiplier symbol set from a multiplier symbol group, and (ii) for a or each multiplier symbol of the selected multiplier symbol set, displaying on the display the or each multiplier symbol in a respective corresponding arrangement position, wherein the or each respective corresponding arrangement position indicates a significant figure of a bonus multiplier; receiving from a server machine a second determination whether or not a second trigger event occurred; responsive to receiving the second determination, when the second trigger event occurred: (i) receiving from the server machine a further multiplier symbol from the multiplier symbol group, and (ii) displaying on the display an augmented bonus multiplier by displaying the or each multiplier symbol in the selected multiplier symbol set in the corresponding arrangement position for the or each respective multiplier symbol in the selected multiplier symbol set and the further multiplier symbol; and when the second trigger event did not occur: displaying on the display the bonus multiplier by displaying the or each multiplier symbol in the selected multiplier symbol set in the corresponding arrangement position for the or each respective multiplier symbol in the selected multiplier symbol set.

### BRIEF DESCRIPTION OF THE DRAWINGS

Some embodiments of the disclosure will now be described by way of example and with reference to the accompanying drawings, in which:

FIG. 1 is a simplified block diagram of an embodiment of a machine in accordance with the disclosure;

FIG. 2 is a simplified block diagram of an example server machine connected to an example client machine over a computer network, in an embodiment of the disclosure;

FIG. 3A is a first part of a flow chart showing functions in accordance with a method in an embodiment of the disclosure;

FIG. 3B is a second part of the flow chart of FIG. 3A;

FIG. 3C is a third part of the flow chart of FIG. 3A;

FIG. 4 includes diagrams of tables used in accordance with machines and methods in embodiments of the disclosure;

FIG. 5 depicts a first state of a display in accordance with an embodiment of a machine and method in accordance with the disclosure;

FIG. 6 depicts a second state of a display in accordance with an embodiment machine and method in accordance with the disclosure;

FIG. 7 depicts a third state of a display in accordance with an embodiment machine and method in accordance with the disclosure;

FIG. 8 depicts a fourth state of a display in accordance with an embodiment machine and method in accordance with the disclosure;

FIG. 9A is a first part of a flow chart showing functions in accordance with another method in an embodiment of the disclosure, in connection with an example server machine;

FIG. 9B is a second part of the flow chart of FIG. 9A;

FIG. 9C is a third part of the flow chart of FIG. 9A;

FIG. 10A is a first part of a flow chart showing functions in accordance with another method in an embodiment of the disclosure, in connection with an example client machine;

FIG. 10B is a second part of the flow chart of FIG. 10A; and

FIG. 10C is a third part of the flow chart of FIG. 10A.

### DETAILED DESCRIPTION

Throughout this disclosure, any reference to “a” or “an” refers to “at least one,” and any reference to “the” refers to “the at least one,” unless otherwise specified, or unless the context clearly dictates otherwise.

Disclosed herein are machines and methods for playing games such as wager games. In one aspect, the machines and methods provide a feature that enhances traditional wager games (e.g., slot machines or other reel-type games) by providing a player with additional opportunities to win the game, thereby increasing the player's interest, anticipation, and excitement in connection with the game. This may in turn benefit a casino or another entity that provides a game with this feature. Indeed, wager games are typically configured to have odds that favor the casino (sometimes referred to as the “house”). Accordingly, based on the law of averages, casinos often maximize their profits simply by getting more players to play more games. Due to the provided feature, players may be drawn in (e.g., from competing casinos that lack games with such a feature) and they may play the game often.

In another aspect, the wager game may be played using non-monetary credits. In such embodiments, the player may not lose or win any money. Further, in such embodiments, the wager game may simulate gambling, without actually allowing the player to gamble money. In some embodiments, the non-monetary credits may be used to unlock additional features within the game, which may encourage the player to play the game.

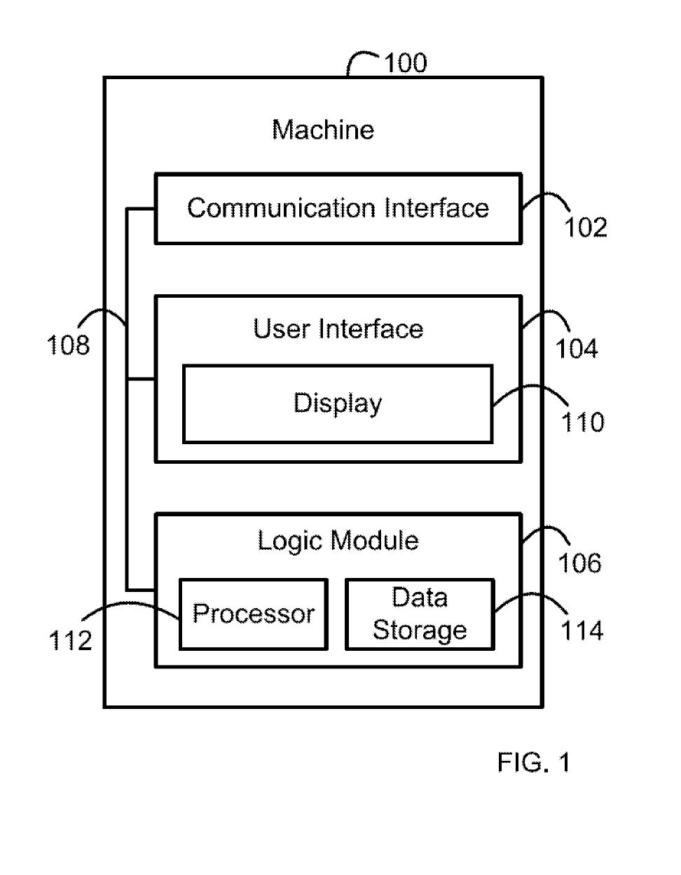

FIG. 1 shows a simplified block diagram of an example machine 100 arranged to implement functions in accordance with example methods described herein. The machine 100 may take any of a variety of forms, including for example a dedicated gaming machine, personal computer, desktop computer, laptop computer, personal digital assistant, mobile phone, smart phone, tablet device, or other computing device.

The machine 100 may include a communication interface 102, a user interface 104, and a logic module 106, all of which may be coupled together by a system bus, network, or other connection mechanism 108. The communication interface 102 may include a wired or wireless network communication interface.

The user interface 104 may facilitate interaction with a user (e.g., a player of a game) if applicable. As such, the user interface 104 may take the form of a GUI and may include output components such as a speaker and a display 110, and input components such as a keypad or a touch-sensitive screen. As described in greater detail below, the display 110 may be configured to display, among other things, a symbol set in a game.

The logic module 106 may take the form of a processor 112 and a data storage 114. The processor 112 may include a general-purpose processor (e.g., a microprocessor) and/or a special-purpose processor (e.g., a digital signal processor and/or application specific integrated circuit) and may be integrated in whole or in part with the communication interface 102 and/or the user interface 104.

The data storage 114 may include volatile and/or non-volatile storage components and may be integrated in whole or in part with the processor 112. The data storage 114 may take the form of a non-transitory computer-readable medium and may include software program instructions, that when executed by the processor 114, cause the machine 100 to perform one or more of the functions described herein.

The data storage 114 may also include operating system software on which the machine 100 may operate. For example, the machine 100 may operate on a Windows™-based operating system (e.g., Windows XP or Windows 7) provided by the Microsoft™ Corporation of Redmond, Wash.

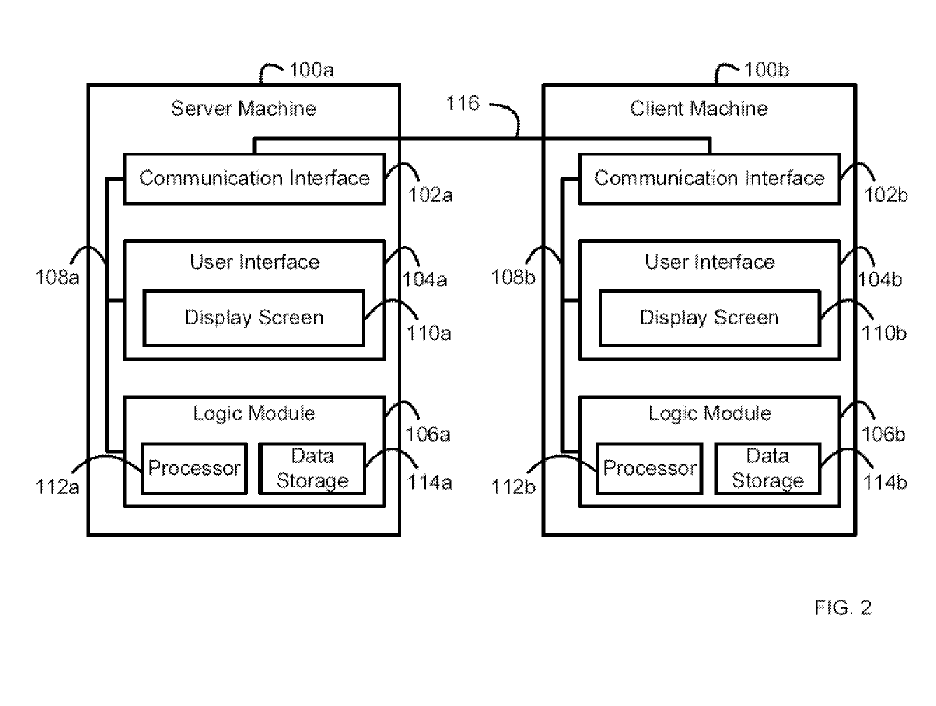

FIG. 2 is a simplified block diagram of an example server machine 100a connected to an example client machine (sometimes referred to as a workstation) 100b over a computer-network 116. The components of the server machine 100a and the client machine 100b are shown with corresponding “a” and “b” reference numerals (i.e., based on the machine 100). The server machine 100a is configured to communicate with the client machine 100b over the computer network 116 (via the communication interfaces 102a, 102b). Likewise, the client machine 100b is configured to communicate with the server machine 100a over the computer network 116. In such server-client based configurations, the server machine 100a and/or the client machine 100b may perform one or more of the functions described herein.

The computer network based server-client configuration described above may take a variety of forms. For example, the computer-network 116 may be a local area network (LAN) in a casino, such that client machines 100b dispersed throughout the casino may communicate with the server machine 100a in the casino.

In another example, the computer-network 116 may be a wide area network (WAN), such as an Internet network. In such a configuration, the client machines 100b may communicate with the server machine 100a via a website portal (for a virtual casino) hosted on the server machine 100a.

The computer-network 116 may include any of a variety of network topologies and network devices, and may employ traditional network-related technologies, including for example the public switched telephone network, cable networks, cellular wireless networks, WiFi, and WiMax. Further, the computer network may include one or more databases (e.g., a player credit account database), to allow for the storing and retrieving of data related to the game.

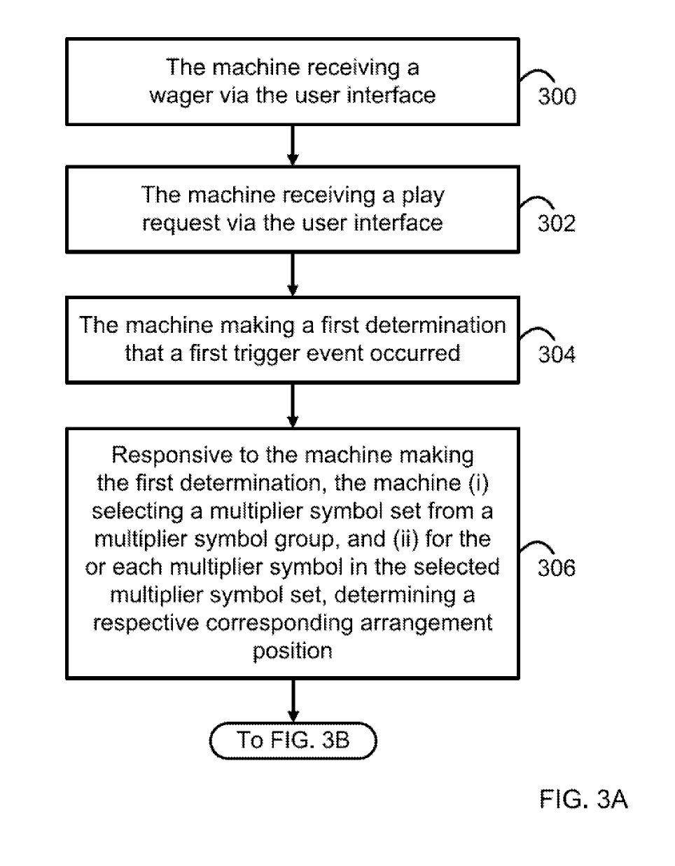

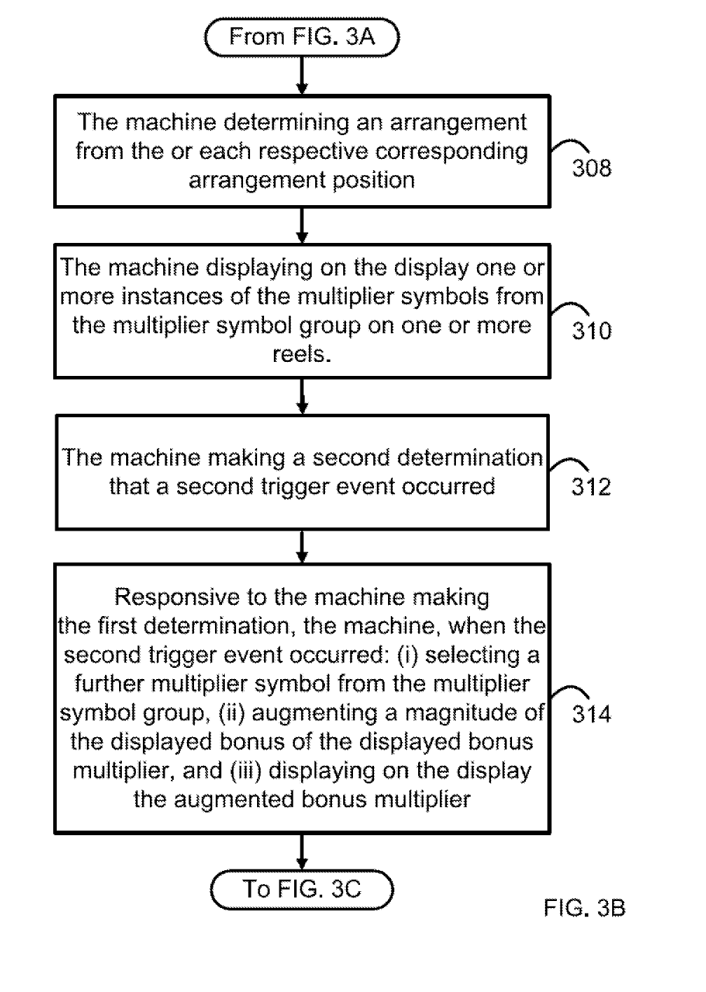

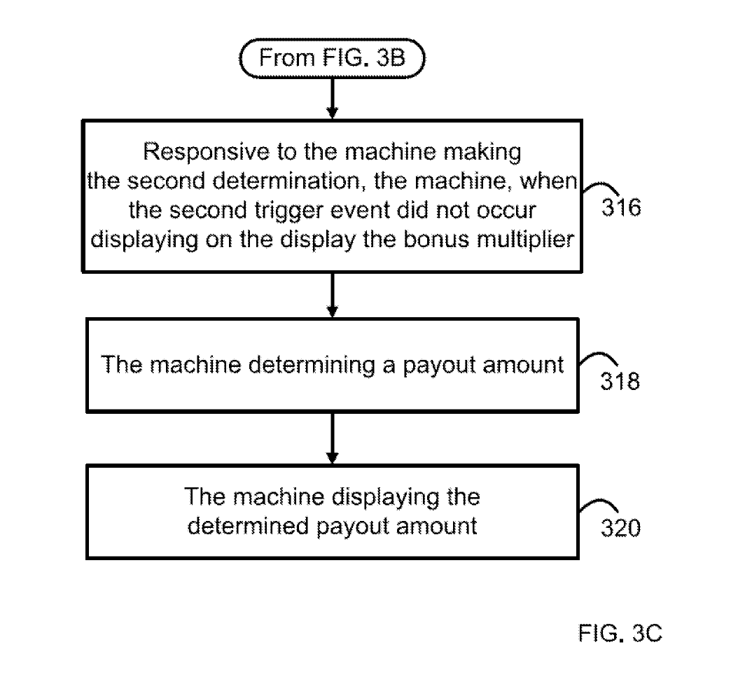

FIGS. 3A-3C show a flow chart showing functions in accordance with an example method in connection with the machine 100. The example method relates to a wager game.

At block 300, the method may involve the machine 100 receiving a wager via the user interface 104. In one example, the wager may include an amount of credits. Or, the wager may include an amount of coins, dollars, chips, or other symbols of value. In one example, receiving a wager may allow a player to enter a wager of the wager game on a keypad on the machine 100. In one example, a player may have a corresponding player credit balance from which the wager may be deducted in response to the machine 100 receiving a play request from the player. For example, a player may have a player credit balance of 100,000, which may be reduced to 99,750 credits upon the player requesting a play of the game with a wager of 250 credits. In one example, the method may further involve the machine 100 displaying on the display 110 the player credit balance and/or the wager amount.

At block 302, the method may involve the machine 100 receiving a play request (e.g., a “spin” request) via the user interface 104. In one example, this may allow a player to pull a level or push a button on the machine 100 to request a play of the wager game. As noted above, this may result in the player's credit balance being reduced by the player's wager.

At block 304, the method may involve the machine 100 making a first determination that a trigger event occurred. The first trigger event may be a randomly occurring event. For example, the first trigger event occurring may involve the machine 100 selecting a trigger symbol from a group of symbols, such as in connection with a previous play of the game. In another example, the first trigger event occurring may involve the machine 100 selecting a trigger symbol for display in a particular arrangement position (e.g., in a middle row or a middle column). As yet another example, the first trigger event may involve the machine 100 selecting, using a random number generator, a number in response to the machine 100 receiving the play request, where the selected number is a trigger number. Note that while a few example trigger events have been described above, any of a variety of other trigger events could be used to suit a desired configuration.

At block 306, the method may involve responsive to the machine 100 making the determination, the machine 100 (i) selecting a multiplier symbol set from a multiplier symbol group, and (ii) for a or each multiplier symbol of the selected multiplier symbol set, determining a respective corresponding arrangement position.

The multiplier symbol group may include one or more multiplier symbols, such as digits 0-9 that may be used in connection with the wager game. The multiplier symbol group may be customized with particular symbols as desired. In some embodiments, the or each multiplier symbol in the multiplier symbol group corresponds to a respective number from a set of numbers. The set of numbers may include numbers 0-9, 0-100, 0-1000, or any other set of numbers.

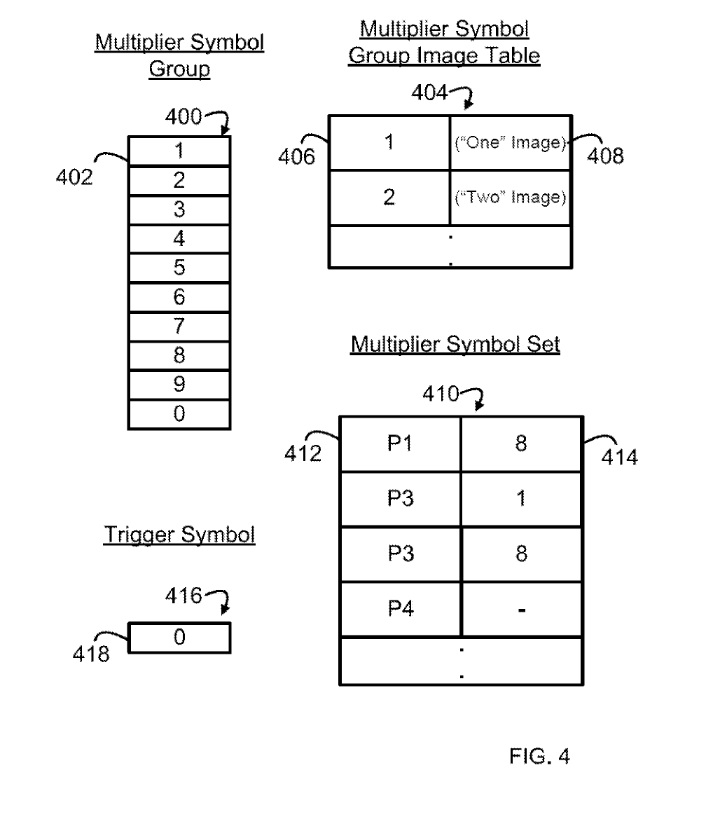

In one example, the multiplier symbol group may be represented as a table (or other data structure) stored in the data storage 114. FIG. 4 shows an example multiplier symbol group 400. The multiplier symbol group 400 includes multiple records 402, each including a particular multiplier symbol.

In some embodiments, the or each multiplier symbol in the multiplier symbol group corresponds with a respective displayable image. In such embodiments, the displayable image may include symbols that represent numbers. For example, one dot may represent “1”, two dots may represent “2”, and so on. As another example, an ace may represent “1” or an image of five hearts may represent a “5.” Other examples are possible as well.

In another example, the multiplier symbol group may be represented as a table (or other data structure) stored in the data storage 114. FIG. 4 shows an example multiplier symbol group image table 404. The multiplier symbol group image table 404 includes multiple records 406, each including an identifier that represents a particular multiplier symbol, such as multiplier symbol 408. The identifier may be used for operations that involve the multiplier symbol. For example, where the multiplier symbol is a displayable image of one dot that represents a “1”, the displayable image may also be associated with the identifier 1. In this arrangement, the number 1 is an identifier to the displayable image.

The multiplier symbol group may include one or more sub-groups. Each sub-group may include one or more multiplier symbols. In some embodiments, the multiplier symbol set may include at least one multiplier symbol selected from each sub-group.

In some embodiments, selecting a multiplier symbol set from the multiplier symbol group may involve randomly selecting one or more multiplier symbols from the multiplier symbol group. The multiplier symbol set may comprise the randomly selected one or more multiplier symbols.

In some embodiments, randomly selecting a multiplier symbol set may not be completely random, but may include an element of randomness, such that the particular multiplier symbols in the multiplier symbol set are not regularly predictable.

In some embodiments, selecting a multiplier symbol set from the multiplier symbol group may involve using a random number generator to select numbers from the set of numbers to select multiplier symbols corresponding with the selected numbers.

In some embodiments, the multiplier symbol set may include one or more instances of the or each multiplier symbol in the multiplier symbol group. For example, where the multiplier symbol group comprises a set of numbers 0-9, the multiplier symbol set may include the numbers 8, 1, 8.

In some embodiments, selecting the multiplier symbol set from the multiplier symbol group may involve determining a quantity of multiplier symbols to select from the multiplier symbol group. The multiplier symbol set may include different amounts of multiplier symbols.

For a or each multiplier symbol of the selected multiplier symbol set, determining a respective corresponding arrangement position may involve the machine arranging the multiplier symbols to indicate a bonus multiplier. For example, where the multiplier symbols in an example multiplier symbol set are “6”, “2”, and “1,” the machine may determine that the “6” is the least significant figure of the bonus multiplier, “2” is the next most significant figure of the bonus multiplier, and “1” is the most significant figure of the bonus multiplier. Or, as another example, where the multiplier symbols in an example multiplier symbol set are “8”, “1”, and “8,” the machine may determine that the first “8” is the least significant figure of the bonus multiplier, “1” is the next most significant figure of the bonus multiplier, and the second “8” is the most significant figure of the bonus multiplier.

In another example, the multiplier symbol set may be represented as a table (or other data structure) stored in the data storage 114. FIG. 4 shows an example multiplier symbol set 410. The multiplier symbol set 410 includes multiple multiplier symbols, such as multiplier symbol 414, each including a respective corresponding arrangement position, such as corresponding arrangement position 412.

Turning to FIG. 3B, at block 308, the method may involve the machine 100 determining an arrangement from the or each respective corresponding arrangement position. Returning to one example above, where the multiplier symbols in an example multiplier symbol set are “6”, “2”, and “1,” the machine may determine the arrangement to be “126” because the machine determined that the “6” is the least significant figure of the bonus multiplier, “2” is the next most significant figure of the bonus multiplier, and “1” is the most significant figure of the bonus multiplier. Or, returning to the other example above, the machine may determine the arrangement to be “818” because the machine determined that the first “8” is the least significant figure of the bonus multiplier, “1” is the next most significant figure of the bonus multiplier, and the second “8” is the most significant figure of the bonus multiplier.

In some embodiments, the arrangement is a linear arrangement. For example, where the multiplier symbols in an example multiplier symbol set are an image of an ace (representing “1”), an image of two spades (representing “2”), and an image of seven hearts (representing “7”), the machine may arrange the images in a linear relationship. For example, this linear relationship may be, left to right, the image of two spades, the image of the ace, and the image of seven hearts. This arrangement indicates a bonus amount of “217.” A linear arrangement may indicate that the multiplier symbols are significant figures of the bonus multiplier. Moreover, this arrangement may indicate the respective positioning of each multiplier symbol as a significant figure with respect to each other multiplier symbol in the multiplier symbol set that is also a significant figure. For example, referring to the multiplier symbols above, “7” is the least significant figure, “1” is the next most significant figure, and “2” is the most significant figure. In other embodiments, the linear relationship may be right to left, up and down, or on a diagonal. Other examples are possible as well.

At block 310, the method may involve the machine 100 displaying on the display one or more instances of the multiplier symbols from the multiplier symbol group on one or more reels, wherein the one or more reels comprise one or more symbol arrangement positions. The wager game may include one or more reels that are displayed on a display, such as display 110, each of which includes multiple multiplier symbols from the multiplier symbol group distributed around the circumference of the reel. In one example, the machine may include three reels, and the pay line may be a horizontal line (e.g. a linear arrangement) disposed across a center of each of the three reels. When the player places a wager and initiates a play request, the reels are spun.

In some embodiments, in which the multiplier symbol group may include one or more sub-groups that include one or more multiplier symbols, each respective sub-group may be distributed around the circumference of one reel. In this arrangement, each sub-group of multiplier symbols is placed on one reel, and the number of sub-groups may correspond to the number of reels.

The one or more reels may be arranged as one or more concentric rings, wherein the one or more symbol arrangement positions are distributed around the circumference of each of the one or more concentric rings. The machine displays the one or more instances of the multiplier symbol group in the one or more symbol arrangement positions. The machine may spin each of the concentric rings around a central axis and then stop each concentric ring so that each multiplier symbol in the multiplier symbol set forms an arrangement. The arrangement may be a linear arrangement, and may indicate a pay line.

In some embodiments, the arrangement indicates a pay line. When the game is a wager game, one or more reels on the display 110 may spin and then come to rest, typically with one or more of the multiplier symbols in the multiplier symbol set arranged to indicate a pay line. This may result in the player winning the game.

In some embodiments, the one or more instances may be the multiplier symbols of the multiplier symbol group. In other embodiments, the one or more instances may be displayable images that indicate that multiplier symbols of the multiplier symbol group.

In the above example in which the reels are displayed as concentric rings, the pay line may be a line or apparent linear arrangement, that intersects one or more multiplier symbols displayed around the circumference of the one or more concentric rings.

In some embodiments, the one or more instances of the multiplier symbols from the multiplier symbol group that are displayed on the one or more reels are weighted. For example, the multiplier symbols displayed on the one or more reels may include many “1” multiplier symbols, such as ten “1” symbols, and few “9” multiplier symbols, such as one or two “9” symbols. This may indicate that the “9” multiplier symbol is not as likely to be selected as part of the multiplier symbol set as the “1” multiplier symbol.

At block 312, the method may involve the machine making a second determination whether or not a second trigger event occurred. In some embodiments, the second trigger event may be a randomly occurring event. For example, the second trigger event occurring may involve the machine 100 selecting a trigger symbol from a group of symbols. In another example, the second trigger event occurring may involve the machine 100 selecting a trigger symbol for display in a particular arrangement position. As yet another example, the trigger event may involve the machine 100 selecting, using a random number generator, a number which is a trigger number. Note that while a few example trigger events have been described above, any of a variety of other trigger events could be used to suit a desired configuration.

In some embodiments, the second trigger event may involve a selecting a particular trigger symbol from the multiplier symbol set and a particular corresponding arrangement position. As one example, the particular trigger symbol may be a “0” and the particular corresponding arrangement position may be the most significant figure. However, the particular trigger symbol may be any multiplier symbol that has been designate as the particular trigger symbol. For example, where the multiplier symbol group is digits 0-9, the particular trigger symbol may be any digit 0-9. In other embodiment, the particular trigger symbol may be any multiplier symbol of the multiplier symbol group. Other examples are possible as well.

More particularly, where the multiplier symbols in an example multiplier symbol set may be “1”, “0, and “9,” the machine may determine that the “1” is the least significant figure of the bonus multiplier, “9” is the next most significant figure of the bonus multiplier, and “0” is the most significant figure of the bonus multiplier. In this example, the machine may make the second determination that a second trigger event occurred because the particular trigger symbol is a “0” and the particular corresponding arrangement position is the most significant figure.

Other trigger conditions are possible as well. For example, one trigger condition may be that all of the multiplier symbols in the multiplier symbol set indicate an odd number. Or, the trigger condition may be that all of the multiplier symbols in the multiplier symbol set may indicate an even number. Another trigger condition may be that all of the multiplier symbols in the multiplier symbol set may indicate the same number or image. Many other examples are possible as well.

At block 314, the method may involve, the machine 100 responsive to making the second determination, when the second trigger event occurred, (i) selecting a further multiplier symbol from the multiplier symbol group, (ii) augmenting a magnitude of the bonus multiplier based on the further multiplier symbol, and (iii) displaying on the display the augmented bonus multiplier by displaying the or each multiplier symbol in the selected multiplier symbol set in the corresponding arrangement position for the or each respective multiplier symbol in the selected multiplier symbol set and the further multiplier symbol.

Selecting a further multiplier symbol from the multiplier symbol group may involve randomly selecting a multiplier symbol from the multiplier symbol group as the further multiplier symbol. Note that, in some embodiments, randomly selecting a further multiplier symbol set may not be completely random, but may include an element of randomness, such that the particular further multiplier symbol is not regularly predictable.

In some embodiments, selecting a further multiplier symbol from the multiplier symbol group may involve using a random number generator to select a number from the set of numbers to select a further multiplier symbol corresponding with the selected number.

In some embodiments, such as where the multiplier symbol group includes one or more sub-groups, the further multiplier may be selected from one sub-group of the one or more sub-groups.

In some embodiments, the further multiplier symbol comprises one or more multiplier symbols from the multiplier symbol set. For example, where the multiplier symbols in an example multiplier symbol set may be “1”, “0, and “9,” the multiplier symbol may be “1”, “0, or “9.”

In some embodiments, the further multiplier symbol in the multiplier symbol group corresponds with a respective displayable image. In such embodiments, the displayable image may include symbols that represent numbers. For example, one dot may represent “1”, two dots may represent “2”, and so on. As another example, an ace may represent “1” or an image of five hearts may represent a “5.” Other examples are possible as well.

In some embodiments, the further multiplier symbol may include more than one multiplier symbol. For example, the further multiplier symbol may include “5” and “0” and the multiplier symbol set may include “0”, “9” and “1”, such that the augmented bonus multiplier becomes “50091.”

In some embodiments, augmenting the magnitude of the bonus multiplier comprises using the further multiplier symbol as a most significant figure of the augmented bonus multiplier. For example, in an example multiplier symbol set that is “1”, “0, and “9” that has determined respective corresponding arrangement positions indicating a bonus amount of “091” and a further multiplier symbol of “5”, the bonus multiplier may be augmented by arranging the “5” multiplier symbol as the most significant figure so that the augment bonus multiplier becomes “5091.”

FIG. 4 shows an example of a trigger symbol 416 that includes a multiplier symbol of “0.”

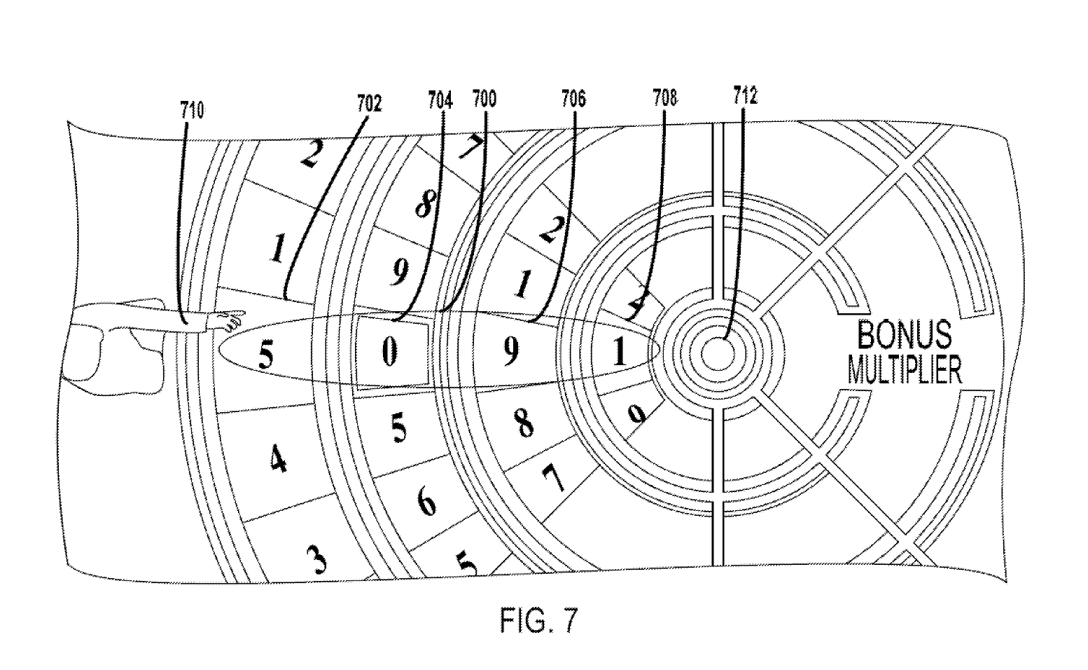

FIG. 7 shows an example of an augmented bonus multiplier 700 that may be displayed on a display, such as display 110. Augmented bonus multiplier 700 is representative of an arrangement. Each of the multiplier symbols “0”, “9”, and “1” are displayed in the corresponding arrangement positions 704, 706, and 708, respectively. In addition, the further multiplier symbol “5” is displayed as the most significant figure of the augmented bonus amount in corresponding arrangement position 702.

Further shown in FIG. 7 is an example in which the one or more reels are arranged as one or more concentric rings, wherein the one or more symbol arrangement positions are distributed around the circumference of each of the one or more concentric rings, as shown. The machine may spin each of the concentric rings around a central axis 712 and then stop each concentric ring so that each multiplier symbol in the multiplier symbol set forms an arrangement, such as the arrangement that corresponds to augmented bonus multiplier 700.

As shown in FIG. 7, one or more of the symbol arrangement positions that distributed around the circumference of the one or more concentric rings may be covered. This may heighten the player's anticipation as to which multiplier symbol may be displayed next when the rings are spun.

Further shown in FIG. 7 is an example of a pay line 710.

As shown, FIG. 7 illustrates a portion of what may be displayed on display 110. In some embodiments, other aspects may be displayed on the display 110 simultaneously.

Turning to FIG. 3C, at block 316, the method may involve the machine 100, when the second trigger event did not occur, displaying on the display the bonus multiplier by displaying the or each multiplier symbol in the selected multiplier symbol set in the corresponding arrangement position for the or each respective multiplier symbol in the selected multiplier symbol set.

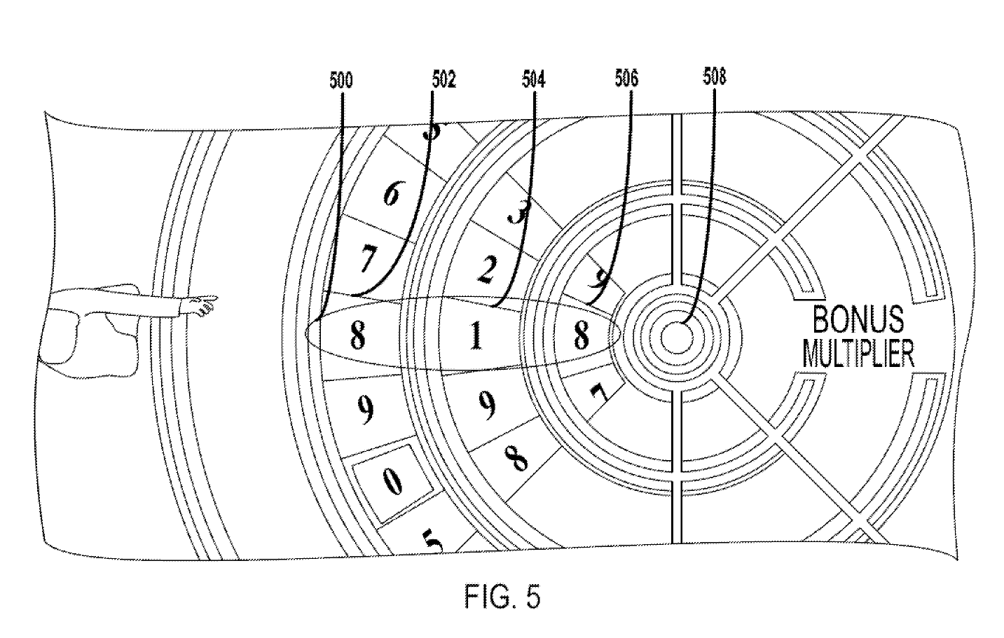

FIG. 5 shows an example of a bonus multiplier 500 that may be displayed on a display, such as display 110. Bonus multiplier 500 is representative of an arrangement. Each of the multiplier symbols “8”, “1”, and “8” are displayed in the corresponding arrangement positions 502, 504, and 506, respectively. Note that in this example, the bonus multiplier is not augmented based on a further multiplier.

Further shown in FIG. 5 is another example in which the one or more reels are arranged as one or more concentric rings, wherein the one or more symbol arrangement positions are distributed around the circumference of each of the one or more concentric rings, as shown. The machine may spin each of the concentric rings around a central axis 508 and then stop each concentric ring so that each multiplier symbol in the multiplier symbol set forms an arrangement, such as the arrangement that corresponds to bonus multiplier 500.

As shown, FIG. 5 illustrates a portion of what may be displayed on display 110. In some embodiments, other aspects may be displayed on the display 110 simultaneously.

At block 318, the method may involve the machine 100 determining, a payout amount. The payout amount may be a function of the received wager, the bonus multiplier, and/or the augmented bonus multiplier. As such, the received wager may be multiplied by the appropriate bonus multiplier to determine the payout amount. As described above, the wager may include, as some examples, credits, coins, chips, or dollars, among other possibilities.

In one example, the machine 100 may also physically dispense a corresponding payout (e.g., cash), or otherwise facilitate the payout to the player (by adding funds to an electronic account associated with a gaming card). Additionally or alternatively to determining the payout amount, the machine 100 may perform other actions to award the player. For instance, the machine may display an indication of a tangible prize. Other types of awards may be used as well.

In one example, when the second trigger event did not occur, the determined payout amount is a function of at least the received wager and the bonus multiplier. For example, where the bonus multiplier is 126 and the wager is 150 credits, the determined payout amount is 126 multiplied by 150 credits, or 18900 credits.

In another example, when the second trigger event occurred, the determined payout amount is a function of at least the received wager and the augmented bonus multiplier. For example, where the bonus multiplier is 1036 and the wager is 150 credits, the determined payout amount is 1036 multiplied by 150 credits, or 155400 credits.

At block 320, the method may involve the machine 100 displaying on the display 110 the determined payout amount. For example, where the machine 100 has determined a payout amount of 500 credits, the machine may display on the display 110 the determined payout amount of 500 credits. Additionally or alternatively, the machine may add the determined payout amount to the player credit balance and display the updated player credit balance. For instance, where the player credit balance was 99,750 credits before the payout amount was determined, the machine 100 may add the determined payout amount of 500 credits to the player credit balance so that the updated balance is 100,250 credits.

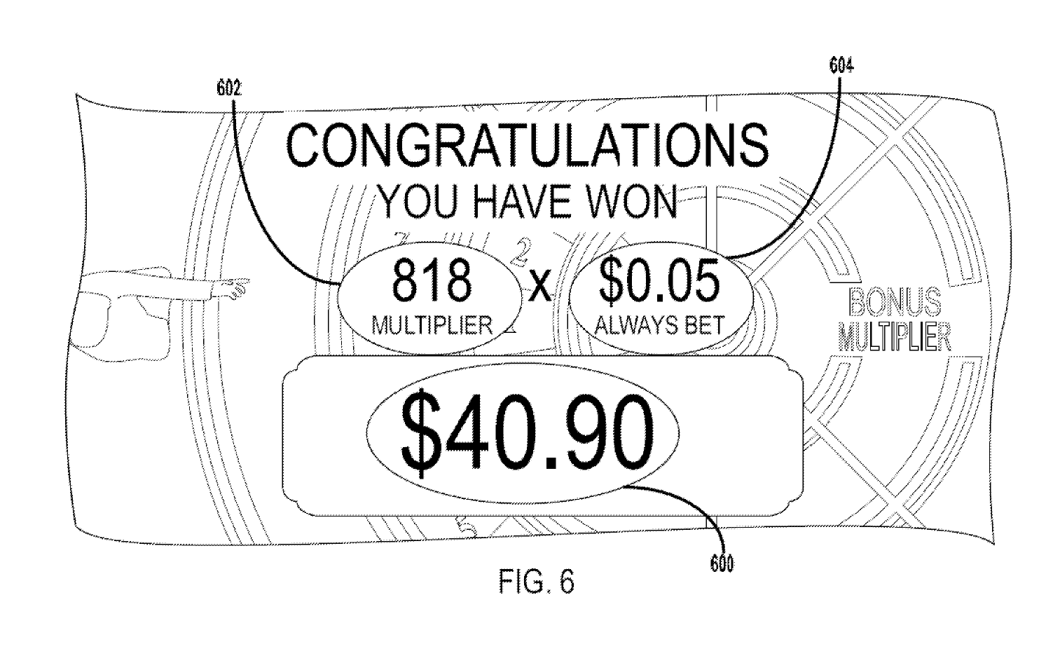

FIG. 6 shows an example of a determined payout amount 600 that may be displayed on a display, such as display 110. In this example, bonus multiplier 602 is 818 and the wager 604 is $0.05. Therefore, the payout amount is 818 multiplied by $0.05, or $40.90. Bonus multiplier 602 in FIG. 6 may correspond to augmented bonus multiplier 500 in FIG. 5.

As shown, FIG. 6 illustrates a portion of what may be displayed on display 110. In some embodiments, other aspects may be displayed on the display 110 simultaneously.

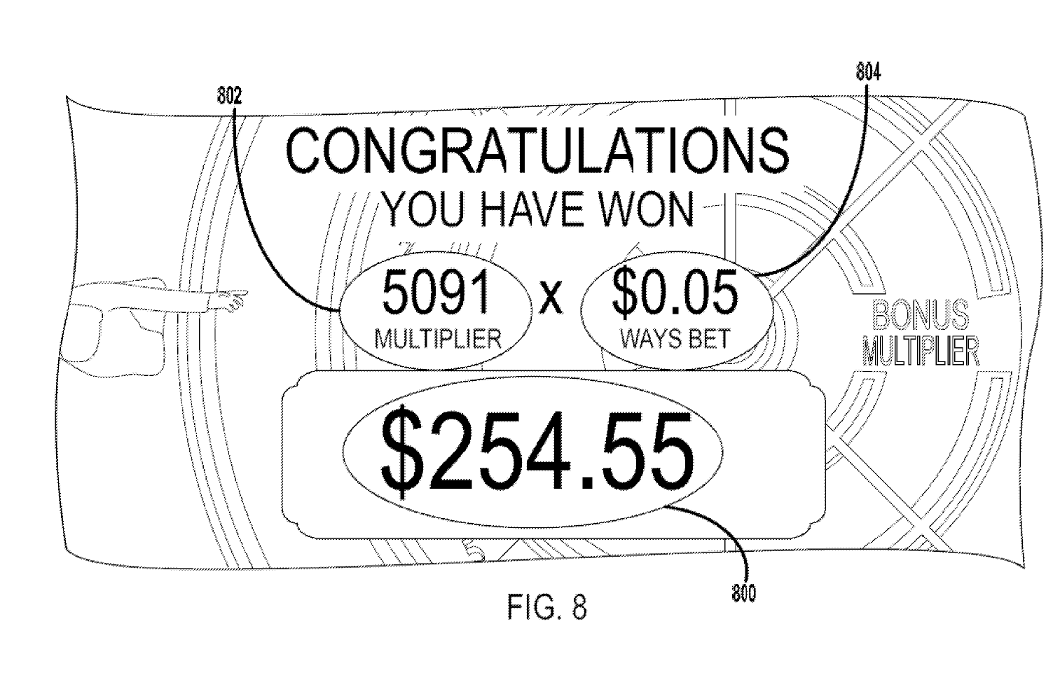

FIG. 8 shows an example of a determined payout amount 800 that may be displayed on a display, such as display 110. In this example, augmented bonus multiplier 802 is 5091 and the wager 804 is $0.05. Therefore, the payout amount is 5091 multiplied by $0.05, or $254,55. Augmented bonus multiplier 802 in FIG. 8 may correspond to augmented bonus multiplier 700 in FIG. 7.

As shown, FIG. 8 illustrates a portion of what may be displayed on display 110. In some embodiments, other aspects may be displayed on the display 110 simultaneously.

In some embodiments, the determined payout amount may be credited to a player account, a player card, or a player wallet. The determined payout amount may increase the amount of credits, coins, chips, dollars, or other value symbols in the player account, the player card, or the player wallet.

In one example where the game emulates a reel-type game, the display 110 shows the symbols in the multiplier symbol group moving while the game simulates a spin of the reels. This may give the appearance to the player that positions corresponding to the symbols in the multiplier symbol set are being randomly determined.

In some embodiments, the game feature described above may be one of multiple game features of a given game. In some instances, the machine 100 may make a determination that a trigger event occurred (e.g., based on a random selection as described above). And in response to making the determination, the machine 100 may randomly select a game feature from a group of game features. Further, in response to selecting the game feature, the machine may perform the appropriate steps to execute the selected game feature. For example, where the game feature is the one described above, in response to selecting the game feature, the machine 100 may make the determination as described above at block 300, and then perform one or more of the other functions described herein in connection with FIGS. 3A-3C to execute the game feature. Note that the group of game features may include a variety of different types of game features.

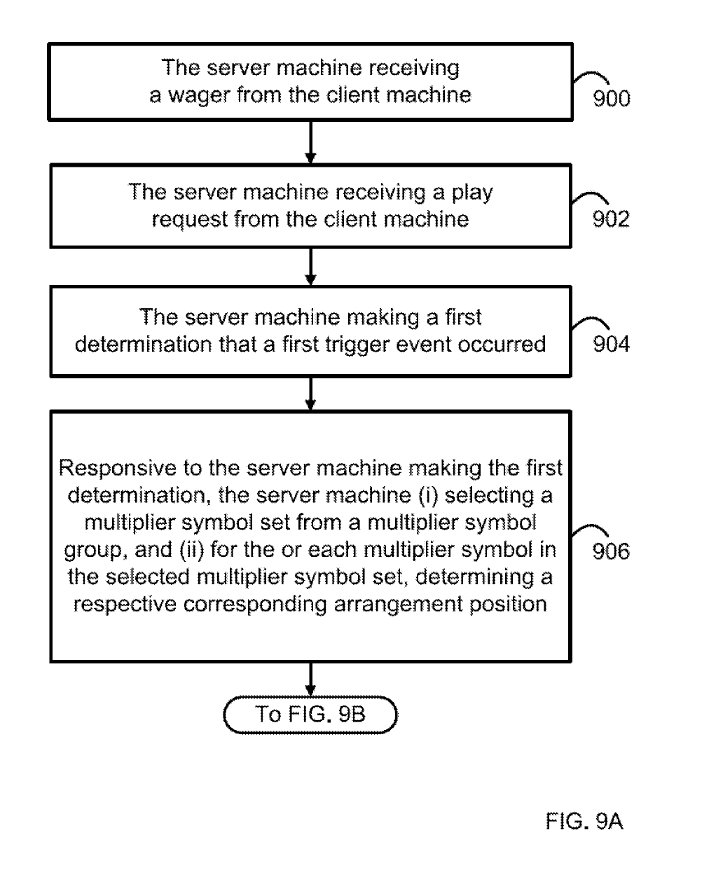

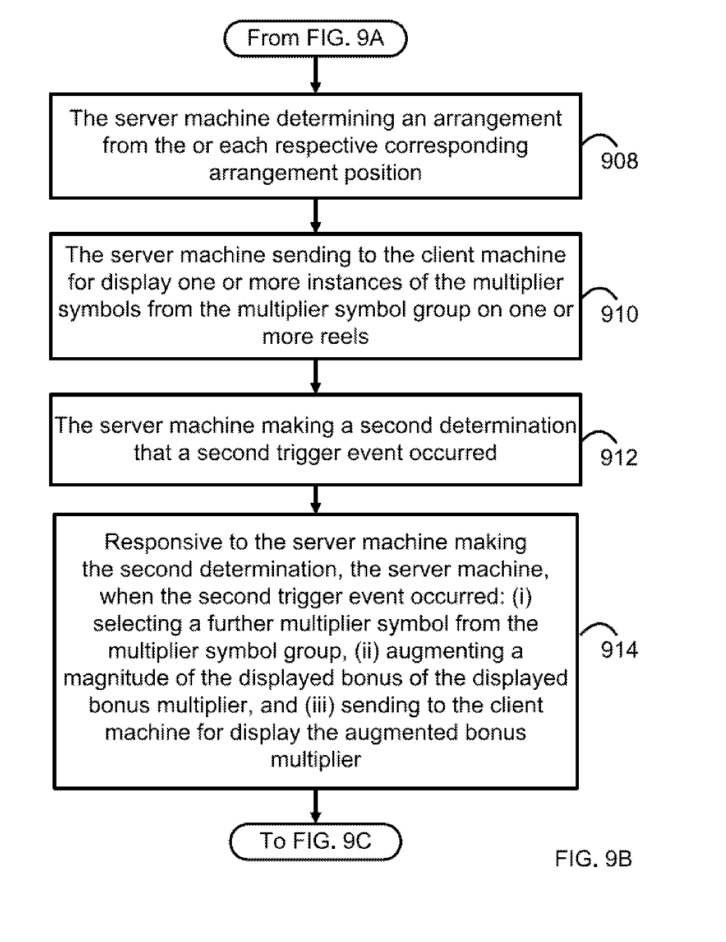

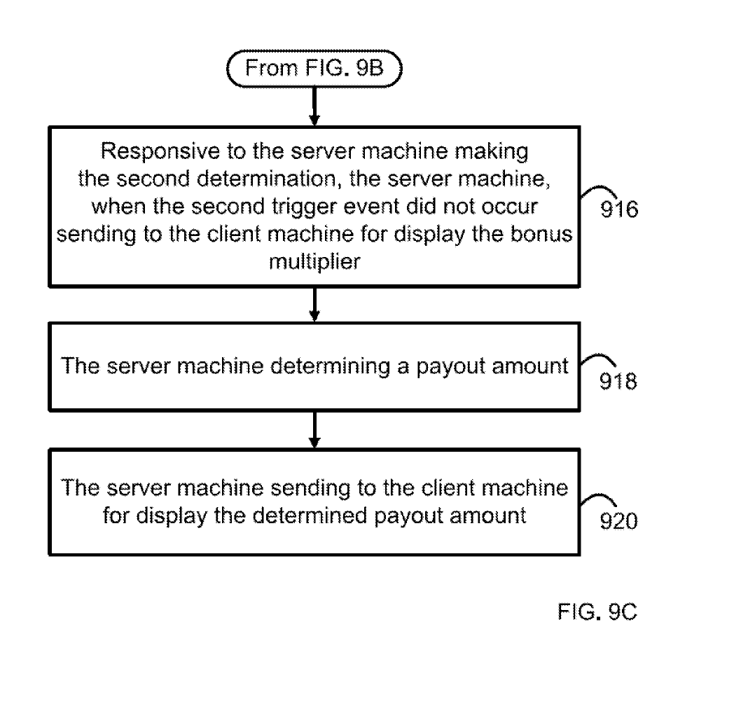

FIGS. 9A-9C show a flow chart showing functions in accordance with an example method in connection with the server machine 100a. Note that several of the functions described in connection with FIGS. 9A-9C parallel functions described in connection with FIGS. 3A-3C. As such, variations of the functions described in connection with FIGS. 3A-3C are likewise applicable to the functions described in connection with FIGS. 9A-9C. However, for the sake of brevity, these variations are not repeated.

At block 900, the method may involve the server machine 100a receiving a wager from the client machine 100b.

At block 902, the method may involve the server machine 100a receiving a play request from the client machine 100b.

At block 904, the method may involve the server machine 100a making a determination that a first trigger event occurred.

At block 906, the method may involve, responsive to the server machine 100a making the first determination, the server machine (i) selecting a multiplier symbol set from a multiplier symbol group, and (ii) for the or each multiplier symbol of the selected multiplier symbol set, determining a respective corresponding arrangement position, wherein the or each respective corresponding arrangement position indicates a significant figure of a bonus multiplier.

Turning to FIG. 9B, at block 908, the method may involve the server machine 100a determining an arrangement from the or each respective corresponding arrangement position.

At block 910, the method may involve the server machine 100a sending to the client machine 100b for display one or more instances of the multiplier symbols from the multiplier symbol group on one or more reels.

At block 912, the method may involve the server machine 100a making a second determination that a second trigger event occurred.

At block 914, the method may involve, responsive to the server machine 100a making the second determination, the server machine, when the second trigger event occurred, (i) selecting a further multiplier symbol from the multiplier symbol group, (ii) augmenting a magnitude of the bonus multiplier based on the further multiplier symbol, and (iii) sending to a client machine for display the augmented bonus multiplier by displaying the or each multiplier symbol in the selected multiplier symbol set in the corresponding arrangement position for the or each respective multiplier symbol in the selected multiplier symbol set and the further multiplier symbol.

Turning to FIG. 9C, at block 916, the method may involve, responsive to the server machine 100a making the second determination, the server machine, when the second trigger event did not occur, sending to the client machine for display the bonus multiplier by displaying the or each multiplier symbol in the selected multiplier symbol set in the corresponding arrangement position for the or each respective multiplier symbol in the selected multiplier symbol set.

At block 918, the method may involve, the server machine 100a determining a payout amount.

At block 920, the method may involve the server machine 100a sending the determined payout amount to the client machine 100b for display on the display 110b.

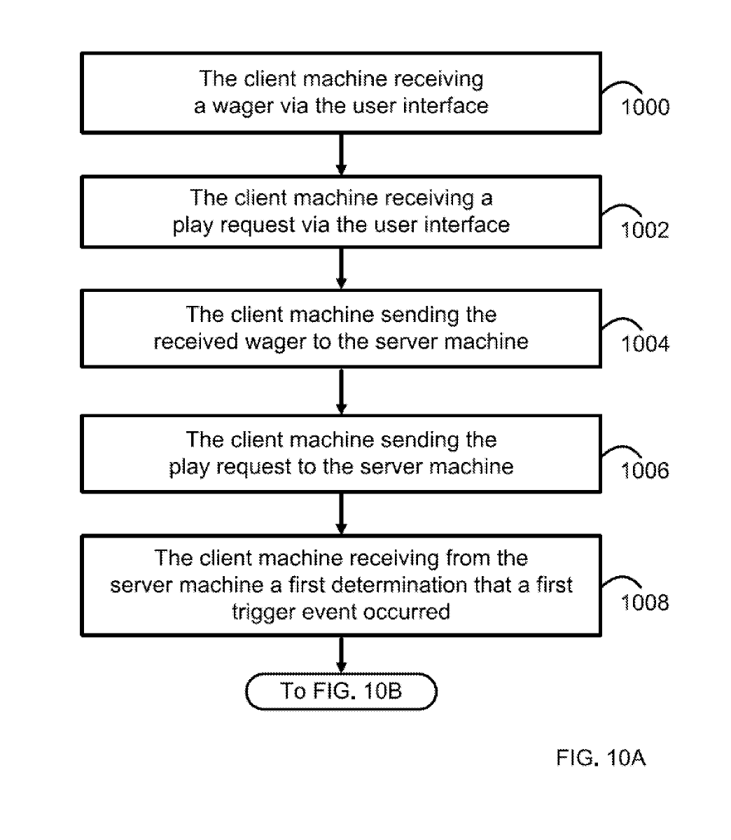

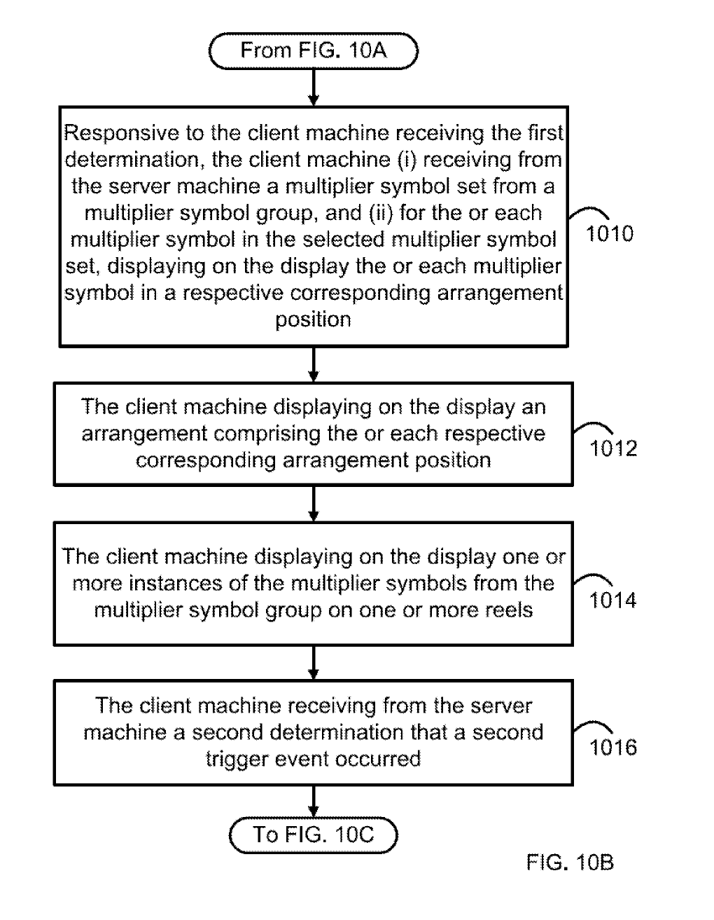

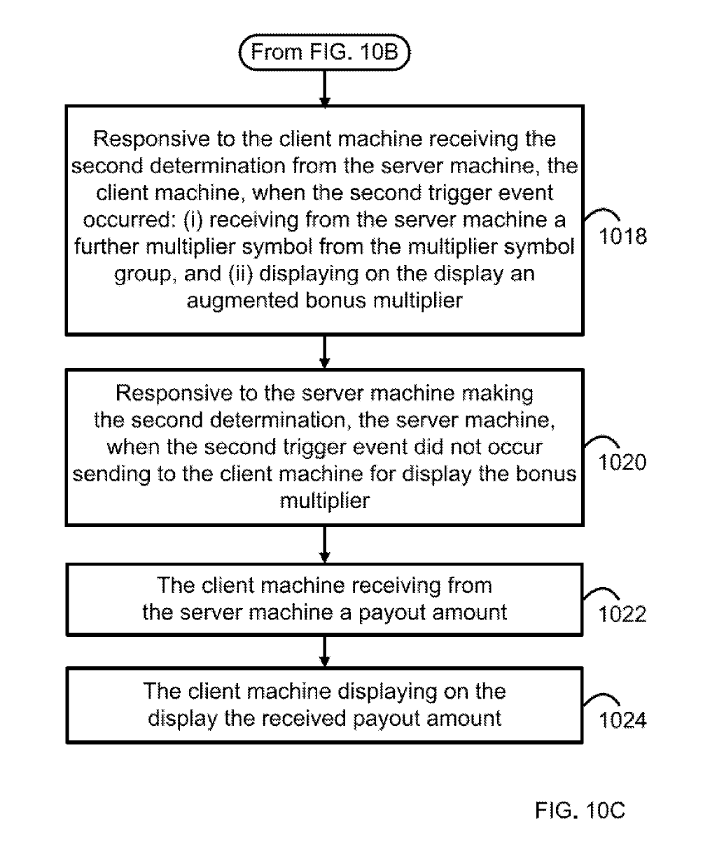

FIGS. 10A-10C show a flow chart showing functions in accordance with an example method in connection with the client machine 100b. Note that several of the functions described in connection with FIGS. 10A-10C parallel functions described in connection with FIGS. 3A-3C and 9A-9C. As such, variations of the functions described in connection with FIGS. 3A-3C and 9A-9C are likewise applicable to the functions described in connection with FIGS. 10A-10C. However, for the sake of brevity, these variations are not repeated.

At block 1000, the method may involve the client machine 100b receiving a wager via the user interface 104b.

At block 1002, the method may involve the client machine 100b receiving a play request via the user interface 104b.

At block 1004, the method may involve the client machine 100b sending the received wager to the server machine 100a.

At block 1006, the method may involve the client machine 100b sending the play request to the server machine 100a.

At block 1008, the method may involve the client machine 100b receiving from the server machine 100a a first determination that a first trigger event occurred.

In some embodiments, the first determination may be an indication that the server machine determined that the first trigger event occurred.

Turning to FIG. 10B, at block 1010, the method may involve the client machine 100b, responsive to receiving the first determination, (i) receiving from the server machine a multiplier symbol set from a multiplier symbol group, and (ii) for a or each multiplier symbol of the selected multiplier symbol set, displaying on the display the or each multiplier symbol in a respective corresponding arrangement position, wherein the or each respective corresponding arrangement position indicates a significant figure of a bonus multiplier.

In some embodiments, when receiving from the server machine a multiplier symbol set from a multiplier symbol group, the client machine may, for example, receive data representing one or more multiplier symbols, respectively. Such data may represent one or more image files. Or, in another example, the client machine may receive data indicating one or more image files representing one or more respective multiplier symbols that are stored at the client device. Or, as a further example, the client machine may receive one or more instructions for the client device to select one or more multiplier symbols.

At block 1012, the method may involve the client machine 100b displaying on the display 110b an arrangement comprising the or each respective corresponding arrangement position.

At block 1014, the method may involve the client machine 100b displaying on the display 110b one or more instances of the multiplier symbols from the multiplier symbol group on one or more reels.

At block 1016, the method may involve the client machine 100b receiving from the server machine 100a a second determination that a second trigger event occurred.

In some embodiments, the second determination may be an indication that the server machine determined that the second trigger event occurred.

Turning to FIG. 10C, at block 1018, the method may involve the client machine 100b, responsive to receiving the second determination, when the second trigger event occurred: (i) receiving from the server machine a further multiplier symbol from the multiplier symbol group, and (ii) displaying on the display an augmented bonus multiplier by displaying the or each multiplier symbol in the selected multiplier symbol set in the corresponding arrangement position for the or each respective multiplier symbol in the selected multiplier symbol set and the further multiplier symbol.

At block 1020, the method may involve the client machine 100b, responsive to receiving the second determination, when the second trigger event did not occur, displaying on the display the bonus multiplier by displaying the or each multiplier symbol in the selected multiplier symbol set in the corresponding arrangement position for the or each respective multiplier symbol in the selected multiplier symbol set.

At block 1022, the method may involve the client machine 100b receiving a payout amount from the server machine 100a.

At block 1024, the method may involve the client machine 100b displaying on the display the received payout amount.

The following examples set out further or alternative aspects of the disclosure. The machine in any of the following examples may be a component of any of the machines described herein or any configuration of a machine described herein.

1. A machine comprising: a display configured to display symbols in a game; a processor; and a non-transitory computer-readable medium storing program instructions, that when executed by the processor, cause a set of functions to be performed, the set of functions comprising:
making a first determination that a first trigger event occurred;
responsive to making the first determination,
   (i) selecting a multiplier symbol set from a multiplier symbol group, and
   (ii) for a or each multiplier symbol of the selected multiplier symbol set, determining a respective corresponding arrangement position, wherein the or each respective corresponding arrangement position indicates a significant figure of a bonus multiplier;
making a second determination whether or not a second trigger event occurred;
responsive to making the second determination,
   when the second trigger event occurred:
      (i) selecting a further multiplier symbol from the multiplier symbol group,
      (ii) augmenting a magnitude of the bonus multiplier based on the further multiplier symbol, and
      (iii) displaying on the display the augmented bonus multiplier by displaying the or each multiplier symbol in the selected multiplier symbol set in the corresponding arrangement position for the or each respective multiplier symbol in the selected multiplier symbol set and the further multiplier symbol; and
   when the second trigger event did not occur:
      displaying on the display the bonus multiplier by displaying the or each multiplier symbol in the selected multiplier symbol set in the corresponding arrangement position for the or each respective multiplier symbol in the selected multiplier symbol set.

2. The machine as recited in example 1, the set of functions further comprising: receiving a play request via a user interface, wherein making the first determination occurs in response to receiving the play request.

3. The machine as recited in example 1 or 2, wherein the first trigger event comprises a randomly occurring event.

4. The machine as recited in one of examples 1-3, wherein the first trigger event comprises selecting a trigger symbol.

5. The machine as recited in one of examples 1-4, wherein the second trigger event comprises a randomly occurring event.

6. The machine as recited in one of examples 1-5, wherein the second trigger event comprises a selecting a particular trigger symbol from the multiplier symbol set and a particular corresponding arrangement position.

7. The machine as recited in example 6, wherein the particular trigger symbol indicates a zero.

8. The machine as recited in one of examples 1-7, wherein the further multiplier symbol comprises one or more multiplier symbols from the multiplier symbol set.

9. The machine as recited in one of examples 1-8, wherein augmenting the magnitude of the bonus multiplier comprises using the further multiplier symbol as a most significant figure of the augmented bonus multiplier.

10. The machine as recited in one of examples 1-9, wherein the or each multiplier symbol in the multiplier symbol group corresponds to a respective number from a set of numbers.

11. The machine as recited in example 10, wherein selecting the multiplier symbol set from the multiplier symbol group comprises using a random number generator to select numbers from the set of numbers to select multiplier symbols corresponding with the selected numbers.

12. The machine as recited in example 10 or 11, wherein selecting the further multiplier symbol from the multiplier symbol group comprises using a random number generator to select at least one number from the set of numbers to select the further multiplier symbol corresponding with the at least one selected number.

13. The machine as recited in one of examples 1-12, wherein the multiplier symbol group comprises one or more instances of the or each multiplier symbol in the multiplier symbol group.

14. The machine as recited in one of examples 1-13, wherein selecting the multiplier symbol set from the multiplier symbol group comprises determining a quantity of multiplier symbols in the multiplier symbol group.

15. The machine as recited in one of examples 1-14, the set of functions further comprising:
determining an arrangement from the or each respective corresponding arrangement position.

16. The machine as recited in example 15, wherein the arrangement is a linear arrangement.

17. The machine as recited in example 15 or 16, wherein the arrangement indicates a pay line.

18. The machine as recited one of examples 1-17, wherein the or each multiplier symbol in the multiplier symbol group corresponds with a respective displayable image, and wherein the further multiplier symbol corresponds with a further displayable image.

19. The machine as recited in example 18, wherein displaying on the display the augmented bonus multiplier comprises, for the or each multiplier symbol of the multiplier symbol set and the further multiplier symbol, displaying a corresponding displayable image.

20. The machine as recited in one of examples 18-19, the set of functions further comprising:
displaying on the display one or more instances of the multiplier symbols from the multiplier symbol group on one or more reels, wherein the one or more reels comprise one or more symbol arrangement positions.

21. The machine as recited in example 20, wherein the one or more reels are arranged as one or more concentric rings, and wherein the one or more symbol arrangement positions are distributed around the circumference of each of the one or more concentric rings.

22. The machine as recited in one of examples 1-21, the set of functions further comprising:
receiving a wager via a user interface; and
determining, a payout amount, wherein the payout amount is a function of at least the received wager.

23. The machine as recited in example 22, wherein, when the second trigger event did not occur, the determined payout amount is a function of at least the received wager and the bonus multiplier.

24. The machine as recited in example 22, wherein, when the second trigger event occurred, the determined payout amount is a function of at least the received wager and the augmented bonus multiplier

25. The machine as recited in one of examples 22-24, the set of functions further comprising:
displaying on the display the determined payout amount.

26. The machine recited in one of examples 1-25, wherein the display is configured to display symbols in a wager game.

27. A method comprising:
a machine making a first determination that a first trigger event occurred;
responsive to making the first determination, the machine
   (i) selecting a multiplier symbol set from a multiplier symbol group, and
   (ii) for a or each multiplier symbol of the selected multiplier symbol set, determining a respective corresponding arrangement position, wherein the or each respective corresponding arrangement position indicates a significant figure of a bonus multiplier;
the machine making a second determination whether or not a second trigger event occurred;
responsive to making the second determination, the machine,
   when the second trigger event occurred:
      (i) selecting a further multiplier symbol from the multiplier symbol group,
      (ii) augmenting a magnitude of the bonus multiplier based on the further multiplier symbol, and
      (iii) displaying on a display the augmented bonus multiplier by displaying the or each multiplier symbol in the selected multiplier symbol set in the corresponding arrangement position for the or each respective multiplier symbol in the selected multiplier symbol set and the further multiplier symbol; and
   when the second trigger event did not occur:
      displaying on the display the bonus multiplier by displaying the or each multiplier symbol in the selected multiplier symbol set in the corresponding arrangement position for the or each respective multiplier symbol in the selected multiplier symbol set.

28. The method as recited in example 27, further comprising:
the machine receiving a play request via a user interface, wherein making the first determination occurs in response to receiving the play request.

29. The method as recited in example 27 or 28, wherein the first trigger event comprises a randomly occurring event.

30. The method as recited in one of examples 27-29, wherein the first trigger event comprises the machine selecting a trigger symbol.

31. The method as recited in one of examples 27-30, wherein the second trigger event comprises a randomly occurring event.

32. The method as recited in one of examples 27-31, wherein the second trigger event comprises the machine a selecting a particular trigger symbol from the multiplier symbol set and a particular corresponding arrangement position.

33. The method as recited in example 32, wherein the particular trigger symbol indicates a zero.

34. The method as recited in one of examples 27-33, wherein the further multiplier symbol comprises one or more multiplier symbols from the multiplier symbol set.

35. The method as recited in one of examples 27-34, wherein the machine augmenting the magnitude of the bonus multiplier comprises the machine using the further multiplier symbol as a most significant figure of the augmented bonus multiplier.

36. The method as recited in one of examples 27-35, wherein the or each multiplier symbol in the multiplier symbol group corresponds to a respective number from a set of numbers.

37. The method as recited in example 36, wherein the machine selecting the multiplier symbol set from the multiplier symbol group comprises the machine using a random number generator to select numbers from the set of numbers to select multiplier symbols corresponding with the selected numbers.

38. The method as recited in example 36 or 37, wherein the machine selecting the further multiplier symbol from the multiplier symbol group comprises the machine using a random number generator to select at least one number from the set of numbers to select the further multiplier symbol corresponding with the at least one selected number.

39. The method as recited in one of examples 27-38, wherein the multiplier symbol set comprises one or more instances of the or each multiplier symbol in the multiplier symbol group.

40. The method as recited in one of examples 27-39, wherein the machine selecting the multiplier symbol set from the multiplier symbol group comprises the machine determining a quantity of multiplier symbols to select from the multiplier symbol group.

41. The method as recited in one of examples 27-40, further comprising:
the machine determining an arrangement from the or each respective corresponding arrangement position.

42. The method as recited in example 41, wherein the arrangement is a linear arrangement.

43. The method as recited in example 40 or 41, wherein the arrangement indicates a pay line.

44. The method as recited one of examples 27-43, wherein the or each multiplier symbol in the multiplier symbol group corresponds with a respective displayable image, and wherein the further multiplier symbol corresponds with a further displayable image.

45. The method as recited in example 44, wherein the machine displaying on the display the augmented bonus multiplier comprises, for the or each multiplier symbol of the multiplier symbol set and the further multiplier symbol, the machine displaying a corresponding displayable image.

46. The method as recited in one of examples 44-45, further comprising:
the machine displaying on the display one or more instances of the multiplier symbols from the multiplier symbol group on one or more reels, wherein the one or more reels comprise one or more symbol arrangement positions.

47. The method as recited in example 46, wherein the one or more reels are arranged as one or more concentric rings, and wherein the one or more symbol arrangement positions are distributed around the circumference of each of the one or more concentric rings.

48. The method as recited in one of examples 27-47, further comprising:
the machine receiving a wager via a user interface; and
the machine determining a payout amount, wherein the payout amount is a function of at least the received wager.

49. The method as recited in example 48, wherein, when the second trigger event did not occur, the determined payout amount is a function of at least the received wager and the bonus multiplier.

50. The method as recited in example 48, wherein, when the second trigger event occurred, the determined payout amount is a function of at least the received wager and the augmented bonus multiplier

51. The method as recited in one of examples 48-50, further comprising:
the machine displaying on the display the determined payout amount.

52. The method recited in one of examples 27-51, wherein the display is configured to display symbols in a wager game.

53. A server machine comprising: a processor; and a non-transitory computer-readable medium storing program instructions, that when executed by the processor, cause a set of functions to be performed, the set of functions comprising:
making a first determination that a first trigger event occurred;
responsive to making the first determination,
   (i) selecting a multiplier symbol set from a multiplier symbol group, and
   (ii) for a or each multiplier symbol of the selected multiplier symbol set, determining a respective corresponding arrangement position, wherein the or each respective corresponding arrangement position indicates a significant figure of a bonus multiplier;
making a second determination whether or not a second trigger event occurred;
responsive to making the second determination,
   when the second trigger event occurred:
      (i) selecting a further multiplier symbol from the multiplier symbol group,
      (ii) augmenting a magnitude of the bonus multiplier based on the further multiplier symbol, and
      (iii) sending to a client machine for display the augmented bonus multiplier by displaying the or each multiplier symbol in the selected multiplier symbol set in the corresponding arrangement position for the or each respective multiplier symbol in the selected multiplier symbol set and the further multiplier symbol; and
   when the second trigger event did not occur:
      sending to the client machine for display the bonus multiplier by displaying the or each multiplier symbol in the selected multiplier symbol set in the corresponding arrangement position for the or each respective multiplier symbol in the selected multiplier symbol set.

54. The server machine as recited in example 53, the set of functions further comprising:
receiving a play request from the client machine, wherein making the first determination occurs in response to receiving the play request.

55. The server machine as recited in example 53 or 54, wherein the first trigger event comprises a randomly occurring event.

56. The server machine as recited in one of examples 53-55, wherein the first trigger event comprises selecting a trigger symbol.

57. The server machine as recited in one of examples 53-56, wherein the second trigger event comprises a randomly occurring event.

58. The server machine as recited in one of examples 53-57, wherein the second trigger event comprises a selecting a particular trigger symbol from the multiplier symbol set and a particular corresponding arrangement position.

59. The server machine as recited in example 58, wherein the particular trigger symbol indicates a zero.

60. The server machine as recited in one of examples 53-59, wherein the further multiplier symbol comprises one or more multiplier symbols from the multiplier symbol set.

61. The server machine as recited in one of examples 53-60, wherein augmenting the magnitude of the bonus multiplier comprises using the further multiplier symbol as a most significant figure of the augmented bonus multiplier.

62. The server machine as recited in one of examples 53-61, wherein the or each multiplier symbol in the multiplier symbol group corresponds to a respective number from a set of numbers.

63. The server machine as recited in example 62, wherein selecting the multiplier symbol set from the multiplier symbol group comprises using a random number generator to select numbers from the set of numbers to select multiplier symbols corresponding with the selected numbers.

64. The server machine as recited in example 62 or 63, wherein selecting the further multiplier symbol from the multiplier symbol group comprises using a random number generator to select at least one number from the set of numbers to select the further multiplier symbol corresponding with the at least one selected number.

65. The server machine as recited in one of examples 53-64, wherein the multiplier symbol set comprises one or more instances of the or each multiplier symbol in the multiplier symbol group.

66. The server machine as recited in one of examples 53-65, wherein selecting the multiplier symbol set from the multiplier symbol group comprises determining a quantity of multiplier symbols to select from the multiplier symbol group.

67. The server machine as recited in one of examples 53-66, the set of functions further comprising:
determining an arrangement from the or each respective corresponding arrangement position.

68. The server machine as recited in example 67, wherein the arrangement is a linear arrangement.

69. The server machine as recited in example 67 or 68, wherein the arrangement indicates a pay line.

70. The server machine as recited one of examples 53-69, wherein the or each multiplier symbol in the multiplier symbol group corresponds with a respective displayable image, and wherein the further multiplier symbol corresponds with a further displayable image.

71. The server machine as recited in example 70, wherein sending to a client machine for display the augmented bonus multiplier comprises, for the or each multiplier symbol of the multiplier symbol set and the further multiplier symbol, sending to the client machine for display a corresponding displayable image.

72. The server machine as recited in one of examples 70-71, the set of functions further comprising:
sending to the client machine for display one or more instances of the multiplier symbols from the multiplier symbol group on one or more reels, wherein the one or more reels comprise one or more symbol arrangement positions.

73. The server machine as recited in example 72, wherein the one or more reels are arranged as one or more concentric rings, and wherein the one or more symbol arrangement positions are distributed around the circumference of each of the one or more concentric rings.

74. The server machine as recited in one of examples 53-73, the set of functions further comprising:
receiving a wager from the client machine; and determining a payout amount, wherein the payout amount is a function of at least the received wager.

75. The server machine as recited in example 74, wherein, when the second trigger event did not occur, the determined payout amount is a function of at least the received wager and the bonus multiplier.

76. The server machine as recited in example 74, wherein, when the second trigger event occurred, the determined payout amount is a function of at least the received wager and the augmented bonus multiplier

77. The server machine as recited in one of examples 74-76, the set of functions further comprising:
sending to the client machine for display the determined payout amount.

78. The server machine recited in one of examples 53-77, wherein the server machine is configured to sending to a client machine for display symbols in a wager game.

79. A client machine comprising: a display configured to display symbols in a game; a processor; and a non-transitory computer-readable medium storing program instructions, that when executed by the processor, cause a set of functions to be performed, the set of functions comprising:
receiving from a server machine a first determination that a first trigger event occurred;
responsive to receiving the first determination,
   (i) receiving from the server machine a multiplier symbol set from a multiplier symbol group, and
   (ii) for a or each multiplier symbol of the selected multiplier symbol set, displaying on the display the or each multiplier symbol in a respective corresponding arrangement position, wherein the or each respective corresponding arrangement position indicates a significant figure of a bonus multiplier;
receiving from a server machine a second determination whether or not a second trigger event occurred;
responsive to receiving the second determination,
   when the second trigger event occurred:
      (i) receiving from the server machine a further multiplier symbol from the multiplier symbol group, and
      (ii) displaying on the display an augmented bonus multiplier by displaying the or each multiplier symbol in the selected multiplier symbol set in the corresponding arrangement position for the or each respective multiplier symbol in the selected multiplier symbol set and the further multiplier symbol; and
   when the second trigger event did not occur:
      displaying on the display the bonus multiplier by displaying the or each multiplier symbol in the selected multiplier symbol set in the corresponding arrangement position for the or each respective multiplier symbol in the selected multiplier symbol set.

80. The client machine as recited in example 79, the set of functions further comprising:
receiving a play request via a user interface, and
sending the play request to a server machine.

81. The client machine as recited in example 79 or 80, wherein the first trigger event comprises a randomly occurring event.

82. The client machine as recited in one of examples 79-81, wherein the first trigger event comprises selecting a trigger symbol.

83. The client machine as recited in one of examples 79-82, wherein the second trigger event comprises a randomly occurring event.

84. The client machine as recited in one of examples 79-83, wherein the second trigger event comprises a selecting a particular trigger symbol from the multiplier symbol set and a particular corresponding arrangement position.

85. The client machine as recited in example 84, wherein the particular trigger symbol indicates a zero.

86. The client machine as recited in one of examples 79-85, wherein the further multiplier symbol comprises one or more multiplier symbols from the multiplier symbol set.

87. The client machine as recited in one of examples 79-86, wherein displaying on the display an augmented bonus multiplier by displaying the or each multiplier symbol in the selected multiplier symbol set in the corresponding arrangement position for the or each respective multiplier symbol in the selected multiplier symbol set and the further multiplier symbol comprises using the further multiplier symbol as a most significant figure of the augmented bonus multiplier.

88. The client machine as recited in one of examples 79-87, wherein the or each multiplier symbol in the multiplier symbol group corresponds to a respective number from a set of numbers.

89. The client machine as recited in one of examples 79-88, wherein the multiplier symbol set comprises one or more instances of the or each multiplier symbol in the multiplier symbol group.

90. The client machine as recited in one of examples 79-89, the set of functions further comprising:
displaying on the display an arrangement comprising the or each respective corresponding arrangement position.

91. The client machine as recited in example 90, wherein the arrangement is a linear arrangement.

92. The client machine as recited in example 90 or 91, wherein the arrangement indicates a pay line.

93. The client machine as recited one of examples 79-92, wherein the or each multiplier symbol in the multiplier symbol group corresponds with a respective displayable image, and wherein the further multiplier symbol corresponds with a further displayable image.

94. The client machine as recited in example 93, wherein displaying on the display the augmented bonus multiplier comprises, for the or each multiplier symbol of the multiplier symbol set and the further multiplier symbol, displaying a corresponding displayable image.

95. The client machine as recited in one of examples 93-94, the set of functions further comprising:
displaying on the display one or more instances of the multiplier symbols from the multiplier symbol group on one or more reels, wherein the one or more reels comprise one or more symbol arrangement positions.

96. The client machine as recited in example 95, wherein the one or more reels are arranged as one or more concentric rings, and wherein the one or more symbol arrangement positions are distributed around the circumference of each of the one or more concentric rings.

97. The client machine as recited in one of examples 79-96, the set of functions further comprising:
receiving a wager via a user interface; and
sending the received wager to the server machine; and
receiving from the server machine a payout amount.

98. The client machine as recited in example 97, wherein, when the second trigger event did not occur, the received payout amount is a function of at least the received wager and the bonus multiplier.

99. The client machine as recited in example 97, wherein, when the second trigger event occurred, the received payout amount is a function of at least the received wager and the augmented bonus multiplier

100. The client machine as recited in one of examples 97-99, the set of functions further comprising:
displaying on the display the determined payout amount.

101. The client machine recited in one of examples 79-100, wherein the display is configured to display symbols in a wager game.

In general, currently there are no machines or methods that allow a player to play a game that involves (i) selecting a multiplier symbol set from a multiplier symbol group, and (ii) for a or each multiplier symbol of the selected multiplier symbol set, determining a respective corresponding arrangement position, wherein the or each respective corresponding arrangement position indicates a significant figure of a bonus multiplier. Then, (i) selecting a further multiplier symbol from the multiplier symbol group, (ii) augmenting a magnitude of the bonus multiplier based on the further multiplier symbol, and (iii) displaying on the display the augmented bonus multiplier by displaying the or each multiplier symbol in the selected multiplier symbol set in the corresponding arrangement position for the or each respective multiplier symbol in the selected multiplier symbol set and the further multiplier symbol.

More particularly, currently, there are no machines or methods to provide a symbol-type game that involves making a first determination that a first trigger event occurred; responsive to making the first determination, (i) selecting a multiplier symbol set from a multiplier symbol group, and (ii) for a or each multiplier symbol of the selected multiplier symbol set, determining a respective corresponding arrangement position, wherein the or each respective corresponding arrangement position indicates a significant figure of a bonus multiplier. Then, making a second determination whether or not a second trigger event occurred; responsive to making the second determination, when the second trigger event occurred: (i) selecting a further multiplier symbol from the multiplier symbol group, (ii) augmenting a magnitude of the bonus multiplier based on the further multiplier symbol, and (iii) displaying on the display the augmented bonus multiplier by displaying the or each multiplier symbol in the selected multiplier symbol set in the corresponding arrangement position for the or each respective multiplier symbol in the selected multiplier symbol set and the further multiplier symbol; and when the second trigger event did not occur: displaying on the display the bonus multiplier by displaying the or each multiplier symbol in the selected multiplier symbol set in the corresponding arrangement position for the or each respective multiplier symbol in the selected multiplier symbol set.

While one or more functions of the presently disclosed method have been described as being performed by the certain entities (e.g., the machine 100, the server machine 100a, or the client machine 100b), one or more of the functions may be performed by any entity, including but not limited to those described herein. As such, while this disclosure includes examples in which the server machine 100a performs select functions and sends data to the client machine 100b, such that the client machine 100b may perform complementing functions and receive the data, variations may to those functions may be made while adhering to the general server-client dichotomy and the scope of the disclosed machines and methods.

For example, rather than the server machine 100a sending select data (e.g., a symbol set) to the client machine 100b, such that the client machine may generate and display appropriate images, the server machine 100a may itself generate the images and send them to the client machine 100b for display. Indeed, it will be appreciated by one of ordinary skill in the art that the “break point” between the server machine's functions and the client machine's functions may be varied with ease.

Further, the described functions throughout this application need not be performed in the disclosed order, although in some examples, the recited order may be preferred. Also, not all functions need to be performed to achieve the desired advantages of disclosed machines and methods, and therefore not all functions are required

While examples have been described in terms of select embodiments, alterations and permutations of these embodiments will be apparent to those of ordinary skill in the art. Other changes, substitutions, and alterations are also possible without departing from the disclosed machines and methods in their broader aspects as set forth in the following claims.

1. A machine comprising: a display configured to display symbols in a game; a processor; and a non-transitory computer-readable medium storing program instructions, that when executed by the processor, cause a set of functions to be performed, the set of functions comprising:
making a first determination that a first trigger event occurred;
responsive to making the first determination,
(i) selecting a multiplier symbol set from a multiplier symbol group, and
(ii) for a or each multiplier symbol of the selected multiplier symbol set, determining a respective corresponding arrangement position, wherein the or each respective corresponding arrangement position indicates a significant figure of a bonus multiplier;
making a second determination whether or not a second trigger event occurred;
responsive to making the second determination,
when the second trigger event occurred:
(i) selecting a further multiplier symbol from the multiplier symbol group,
(ii) augmenting a magnitude of the bonus multiplier based on the further multiplier symbol, and
(iii) displaying on the display the augmented bonus multiplier by displaying the or each multiplier symbol in the selected multiplier symbol set in the corresponding arrangement position for the or each respective multiplier symbol in the selected multiplier symbol set and the further multiplier symbol; and
when the second trigger event did not occur:
displaying on the display the bonus multiplier by displaying the or each multiplier symbol in the selected multiplier symbol set in the corresponding arrangement position for the or each respective multiplier symbol in the selected multiplier symbol set.

2. The machine as recited in claim 1, wherein the second trigger event comprises selecting a particular trigger symbol from the multiplier symbol set and a particular corresponding arrangement position.

3. The machine as recited in claim 1, wherein the further multiplier symbol comprises one or more multiplier symbols from the multiplier symbol set.

4. The machine as recited in claim 1, wherein augmenting the magnitude of the bonus multiplier comprises using the further multiplier symbol as a most significant figure of the augmented bonus multiplier.

5. The machine as recited in claim 1, wherein the or each multiplier symbol in the multiplier symbol group corresponds to a respective number from a set of numbers.

6. The machine as recited in 5, wherein selecting the multiplier symbol set from the multiplier symbol group comprises using a random number generator to select numbers from the set of numbers to select multiplier symbols corresponding with the selected numbers.

7. The machine as recited in claim 5, wherein selecting the further multiplier symbol from the multiplier symbol group comprises using a random number generator to select at least one number from the set of numbers to select the further multiplier symbol corresponding with the at least one selected number.

8. The machine as recited in claim 1, wherein the multiplier symbol group comprises one or more instances of the or each multiplier symbol in the multiplier symbol group.

9. The machine as recited in claim 1, wherein the or each multiplier symbol in the multiplier symbol group corresponds with a respective displayable image, and wherein the further multiplier symbol corresponds with a further displayable image.

10. The machine as recited in claim 9, the set of functions further comprising:
displaying on the display one or more instances of the multiplier symbols from the multiplier symbol group on one or more reels, wherein the one or more reels comprise one or more symbol arrangement positions.

11. The machine as recited in claim 10, wherein the one or more reels are arranged as one or more concentric rings, and wherein the one or more symbol arrangement positions are distributed around the circumference of each of the one or more concentric rings.

12. A method comprising:
a machine making a first determination that a first trigger event occurred;
responsive to making the first determination, the machine
(i) selecting a multiplier symbol set from a multiplier symbol group, and
(ii) for a or each multiplier symbol of the selected multiplier symbol set, determining a respective corresponding arrangement position, wherein the or each respective corresponding arrangement position indicates a significant figure of a bonus multiplier;
the machine making a second determination whether or not a second trigger event occurred;
responsive to making the second determination, the machine,
when the second trigger event occurred:
(i) selecting a further multiplier symbol from the multiplier symbol group,
(ii) augmenting a magnitude of the bonus multiplier based on the further multiplier symbol, and
(iii) displaying on a display the augmented bonus multiplier by displaying the or each multiplier symbol in the selected multiplier symbol set in the corresponding arrangement position for the or each respective multiplier symbol in the selected multiplier symbol set and the further multiplier symbol; and
when the second trigger event did not occur:
displaying on the display the bonus multiplier by displaying the or each multiplier symbol in the selected multiplier symbol set in the corresponding arrangement position for the or each respective multiplier symbol in the selected multiplier symbol set.

13. The method as recited in claim 12, further comprising:
the machine receiving a play request via a user interface, wherein making the first determination occurs in response to receiving the play request.

14. The method as recited in claim 12, wherein the second trigger event comprises the machine a selecting a particular trigger symbol from the multiplier symbol set and a particular corresponding arrangement position.

15. The method as recited in claim 13, further comprising:
the machine determining an arrangement from the or each respective corresponding arrangement position.

16. The method as recited in claim 15, wherein the arrangement is a linear arrangement.

17. The method as recited in claim 15, wherein the arrangement indicates a pay line.

18. The method as recited in claim 13, further comprising:
the machine receiving a wager via a user interface; and
the machine determining a payout amount, wherein the payout amount is a function of at least the received wager.

19. The method as recited in claim 18, wherein, when the second trigger event occurred, the determined payout amount is a function of at least the received wager and the augmented bonus multiplier

20. A server machine comprising: a processor; and a non-transitory computer-readable medium storing program instructions, that when executed by the processor, cause a set of functions to be performed, the set of functions comprising:
making a first determination that a first trigger event occurred;
responsive to making the first determination,
(i) selecting a multiplier symbol set from a multiplier symbol group, and
(ii) for a or each multiplier symbol of the selected multiplier symbol set, determining a respective corresponding arrangement position, wherein the or each respective corresponding arrangement position indicates a significant figure of a bonus multiplier;
making a second determination whether or not a second trigger event occurred;
responsive to making the second determination,
when the second trigger event occurred:
(i) selecting a further multiplier symbol from the multiplier symbol group,
(ii) augmenting a magnitude of the bonus multiplier based on the further multiplier symbol, and
(iii) sending to a client machine for display the augmented bonus multiplier by displaying the or each multiplier symbol in the selected multiplier symbol set in the corresponding arrangement position for the or each respective multiplier symbol in the selected multiplier symbol set and the further multiplier symbol; and
when the second trigger event did not occur:
sending to the client machine for display the bonus multiplier by displaying the or each multiplier symbol in the selected multiplier symbol set in the corresponding arrangement position for the or each respective multiplier symbol in the selected multiplier symbol set.

21. A client machine comprising: a display configured to display symbols in a game;
a processor; and a non-transitory computer-readable medium storing program instructions, that when executed by the processor, cause a set of functions to be performed, the set of functions comprising:
receiving from a server machine a first determination that a first trigger event occurred;
responsive to receiving the first determination,
(i) receiving from the server machine a multiplier symbol set from a multiplier symbol group, and
(ii) for a or each multiplier symbol of the selected multiplier symbol set, displaying on the display the or each multiplier symbol in a respective corresponding arrangement position, wherein the or each respective corresponding arrangement position indicates a significant figure of a bonus multiplier;
receiving from a server machine a second determination whether or not a second trigger event occurred;
responsive to receiving the second determination,
when the second trigger event occurred:
(i) receiving from the server machine a further multiplier symbol from the multiplier symbol group, and
(ii) displaying on the display an augmented bonus multiplier by displaying the or each multiplier symbol in the selected multiplier symbol set in the corresponding arrangement position for the or each respective multiplier symbol in the selected multiplier symbol set and the further multiplier symbol; and
when the second trigger event did not occur:
displaying on the display the bonus multiplier by displaying the or each multiplier symbol in the selected multiplier symbol set in the corresponding arrangement position for the or each respective multiplier symbol in the selected multiplier symbol set.
